(19) United States
(12) Patent Application Publication
(10) Pub. No.: US 2026/0020073 A1
(43) Pub. Date: Jan. 15, 2026

(54) SELECTION OF RANDOM ACCESS RESOURCE

(71) Applicant: QUALCOMM Incorporated, San Diego, CA (US)

(72) Inventors: Shaozhen GUO, Beijing (CN); Mostafa KHOSHNEVISAN, San Diego, CA (US)

(21) Appl. No.: 18/992,533

(22) PCT Filed: Aug. 19, 2022
(86) PCT No.: PCT/CN2022/113554

§ 371 Date: Jan. 8, 2025

(51) Int. Cl. H04W 74/0833; H04W 56/00

(52) U.S. Cl. CPC H04W 74/0833; H04W 56/001

(57) ABSTRACT

Aspects relate to selection of a resource for a random access procedure. In some examples, a user equipment may transmit a random access message on a resource associated with a control resource set pool index value. In some examples, a user equipment may transmit a random access message on a resource associated with a physical cell identifier.

### TECHNICAL FIELD

The technology discussed below relates generally to wireless communication and, more particularly, to the selection of a random access resource for transmission of a random access message.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include a memory, and a processor coupled to the memory. The processor and the memory may be configured to transmit a first random access message for a random access procedure to a network entity, the first random access message being transmitted via a first random access resource of a set of random access resources associated with a first control resource set pool index value of a plurality of control resource set pool index values. The processor and the memory may also be configured to receive a second random access message from the network entity, the second random access message including timing advance information. The processor and the memory may be further configured to transmit a message to the network entity based on the timing advance information.

In some examples, a method for wireless communication at a user equipment is disclosed. The method may include transmitting a first random access message for a random access procedure to a network entity, the first random access message being transmitted via a first random access resource of a set of random access resources associated with a first control resource set pool index value of a plurality of control resource set pool index values. The method may also include receiving a second random access message from the network entity, the second random access message including timing advance information. The method may further include transmitting a message to the network entity based on the timing advance information.

In some examples, a user equipment may include means for transmitting a first random access message for a random access procedure to a network entity, the first random access message being transmitted via a first random access resource of a set of random access resources associated with a first control resource set pool index value of a plurality of control resource set pool index values. The user equipment may also include means for receiving a second random access message from the network entity, the second random access message including timing advance information. The user equipment may further include means for transmitting a message to the network entity based on the timing advance information.

In some examples, a non-transitory computer-readable medium has stored therein instructions executable by one or more processors of a user equipment to transmit a first random access message for a random access procedure to a network entity, the first random access message being transmitted via a first random access resource of a set of random access resources associated with a first control resource set pool index value of a plurality of control resource set pool index values. The computer-readable medium may also have stored therein instructions executable by one or more processors of the user equipment to receive a second random access message from the network entity, the second random access message including timing advance information. The computer-readable medium may further have stored therein instructions executable by one or more processors of the user equipment to transmit a message to the network entity based on the timing advance information.

In some examples, a user equipment may include a memory, and a processor coupled to the memory. The processor and the memory may be configured to transmit a first random access message for a random access procedure to a network entity, the first random access message being transmitted via a first random access resource of a set of random access resources associated with a first physical cell identifier of a plurality of physical cell identifiers. The processor and the memory may also be configured to receive a second random access message from the network entity, the second random access message including timing advance information. The processor and the memory may be further configured to transmit a message to the network entity based on the timing advance information.

In some examples, a method for wireless communication at a user equipment is disclosed. The method may include transmitting a first random access message for a random access procedure to a network entity, the first random access message being transmitted via a first random access resource of a set of random access resources associated with a first physical cell identifier of a plurality of physical cell identifiers. The method may also include receiving a second random access message from the network entity, the second random access message including timing advance information. The method may further include transmitting a message to the network entity based on the timing advance information.

In some examples, a user equipment may include means for transmitting a first random access message for a random access procedure to a network entity, the first random access message being transmitted via a first random access resource of a set of random access resources associated with a first physical cell identifier of a plurality of physical cell identifiers. The user equipment may also include means for receiving a second random access message from the network entity, the second random access message including timing advance information. The user equipment may further include means for transmitting a message to the network entity based on the timing advance information.

In some examples, a non-transitory computer-readable medium has stored therein instructions executable by one or more processors of a user equipment to transmit a first random access message for a random access procedure to a network entity, the first random access message being transmitted via a first random access resource of a set of random access resources associated with a first physical cell identifier of a plurality of physical cell identifiers. The computer-readable medium may also have stored therein instructions executable by one or more processors of the user equipment to receive a second random access message from the network entity, the second random access message including timing advance information. The computer-readable medium may further have stored therein instructions executable by one or more processors of the user equipment to transmit a message to the network entity based on the timing advance information.

In some examples, a network entity may include a memory, and a processor coupled to the memory. The processor and the memory may be configured to receive a first random access message for a random access procedure from a user equipment, the first random access message being received via a first random access resource of a set of random access resources associated with a first control resource set pool index value of a plurality of control resource set pool index values. The processor and the memory may also be configured to transmit a second random access message to the user equipment, the second random access message including timing advance information. The processor and the memory may be further configured to receive a message from the user equipment based on the timing advance information.

In some examples, a method for wireless communication at a network entity is disclosed. The method may include receiving a first random access message for a random access procedure from a user equipment, the first random access message being received via a first random access resource of a set of random access resources associated with a first control resource set pool index value of a plurality of control resource set pool index values. The method may also include transmitting a second random access message to the user equipment, the second random access message including timing advance information. The method may further include receiving a message from the user equipment based on the timing advance information.

In some examples, a network entity may include means for receiving a first random access message for a random access procedure from a user equipment, the first random access message being received via a first random access resource of a set of random access resources associated with a first control resource set pool index value of a plurality of control resource set pool index values. The network entity may also include means for transmitting a second random access message to the user equipment, the second random access message including timing advance information. The network entity may further include means for receiving a message from the user equipment based on the timing advance information.

In some examples, a non-transitory computer-readable medium has stored therein instructions executable by one or more processors of a network entity to receive a first random access message for a random access procedure from a user equipment, the first random access message being received via a first random access resource of a set of random access resources associated with a first control resource set pool index value of a plurality of control resource set pool index values. The computer-readable medium may also have stored therein instructions executable by one or more processors of the network entity to transmit a second random access message to the user equipment, the second random access message including timing advance information. The computer-readable medium may further have stored therein instructions executable by one or more processors of the network entity to receive a message from the user equipment based on the timing advance information.

In some examples, a network entity may include a memory, and a processor coupled to the memory. The processor and the memory may be configured to receive a first random access message for a random access procedure from a user equipment, the first random access message being received via a first random access resource of a set of random access resources associated with a first physical cell identifier of a plurality of physical cell identifiers. The processor and the memory may also be configured to transmit a second random access message to the user equipment, the second random access message including timing advance information. The processor and the memory may be further configured to receive a message from the user equipment based on the timing advance information.

In some examples, a method for wireless communication at a network entity is disclosed. The method may include receiving a first random access message for a random access procedure from a user equipment, the first random access message being received via a first random access resource of a set of random access resources associated with a first physical cell identifier of a plurality of physical cell identifiers. The method may also include transmitting a second random access message to the user equipment, the second random access message including timing advance information. The method may further include receiving a message from the user equipment based on the timing advance information.

In some examples, a network entity may include means for receiving a first random access message for a random access procedure from a user equipment, the first random access message being received via a first random access resource of a set of random access resources associated with a first physical cell identifier of a plurality of physical cell identifiers. The network entity may also include means for transmitting a second random access message to the user equipment, the second random access message including timing advance information. The network entity may further include means for receiving a message from the user equipment based on the timing advance information.

In some examples, a non-transitory computer-readable medium has stored therein instructions executable by one or more processors of a network entity to receive a first random access message for a random access procedure from a user equipment, the first random access message being received via a first random access resource of a set of random access resources associated with a first physical cell identifier of a plurality of physical cell identifiers. The computer-readable medium may also have stored therein instructions executable by one or more processors of the network entity to transmit a second random access message to the user equipment, the second random access message including timing advance information. The computer-readable medium may further have stored therein instructions executable by one or more processors of the network entity to receive a message from the user equipment based on the timing advance information.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a diagram illustrating an example of a frame structure of synchronization signals for use in a wireless communication network according to some aspects.

FIG. 6 is a signaling diagram of an example of random access channel (RACH) related signaling according to some aspects.

FIG. 7 is a schematic illustration of an example of a downlink control region of a slot according to some aspects.

FIG. 8 is a conceptual illustration of uplink and downlink timing according to some aspects.

FIG. 9 is a conceptual illustration of an example of a user equipment (UE) communicating with multiple transmit receive points (TRPs) according to some aspects.

FIG. 10 is a conceptual illustration of uplink and downlink timing associated with multiple TRPs according to some aspects.

FIG. 11 is a signaling diagram illustrating an example of signaling associated with random access resource selection for an intra-cell scenario where a contention-based random access procedure is triggered by a physical downlink control channel order according to some aspects.

FIG. 12 is a signaling diagram illustrating an example of signaling associated with random access resource selection for an intra-cell scenario where a contention-based random access procedure is triggered by a user equipment according to some aspects.

FIG. 13 is a signaling diagram illustrating an example of signaling associated with random access resource selection for an inter-cell scenario where a contention-based random access procedure is triggered by a physical downlink control channel order according to some aspects.

FIG. 14 is a block diagram conceptually illustrating an example of a hardware implementation for a user equipment employing a processing system according to some aspects.

FIG. 15 is a flow chart illustrating an example wireless communication method involving transmitting a random access message on a resource associated with a control resource set pool index according to some aspects.

FIG. 16 is a flow chart illustrating an example wireless communication method involving transmitting a random access message on a resource associated with a physical cell identifier according to some aspects.

FIG. 17 is a block diagram conceptually illustrating an example of a hardware implementation for a network entity employing a processing system according to some aspects.

FIG. 18 is a flow chart illustrating an example wireless communication method involving receiving a random access message on a resource associated with a control resource set pool index according to some aspects.

FIG. 19 is a flow chart illustrating an example wireless communication method involving receiving a random access message on a resource associated with a physical cell identifier according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to selection of a resource for a random access procedure. In some aspects, the selection of such a resource may involve selecting a synchronization signal block of a set of synchronization signal blocks associated with a transmit receive point and identifying a random access resource associated with the selected synchronization signal block.

In some examples, different control resource set pool index values may be associated with different TRPs that are, in turn, associated with different sets of synchronization signal blocks. In this case, a user equipment may select a synchronization signal block from a set of synchronization signal blocks associated with a particular control resource set pool index value, identify a random access resource associated with the selected synchronization signal block, and transmit a random access message on the identified resource.

In some examples, different physical cell identifiers may be associated with different TRPs that are, in turn, associated with different sets of synchronization signal blocks. In this case, a user equipment may select a synchronization signal block from a set of synchronization signal blocks associated with a particular physical cell identifier, identify a random access resource associated with the selected synchronization signal block, and transmit a random access message on the identified resource.

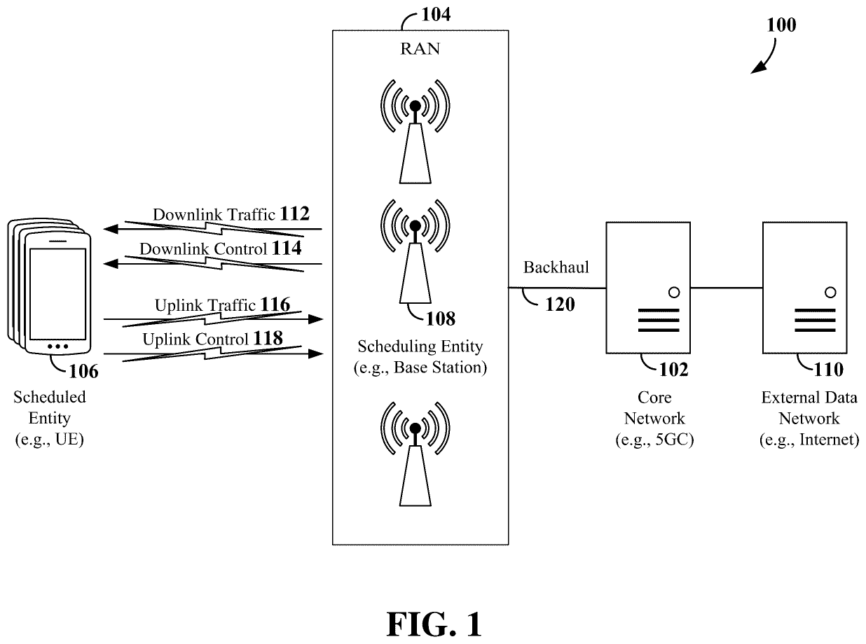

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network—New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IOT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

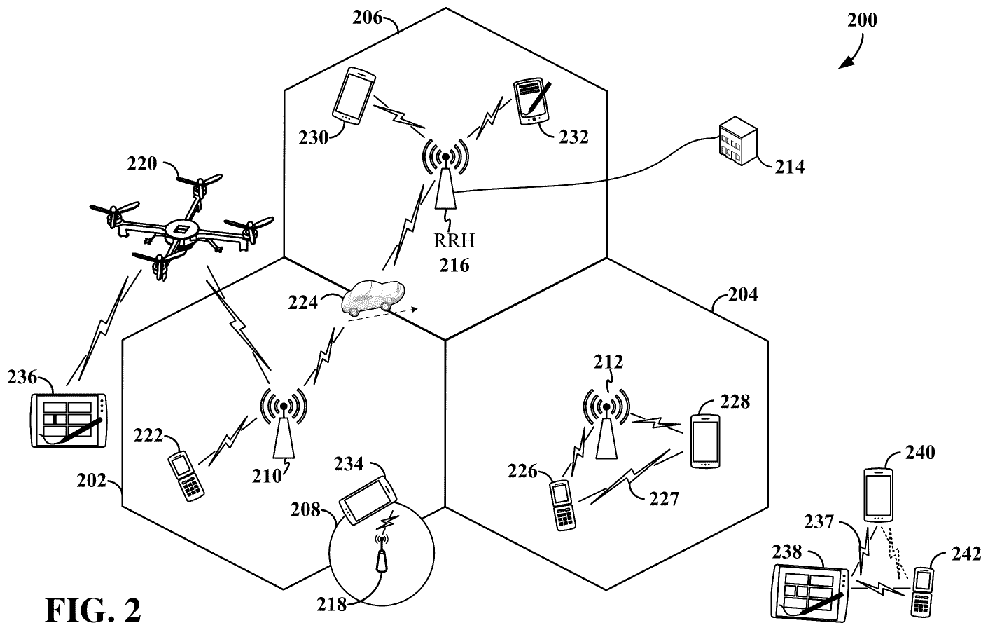

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

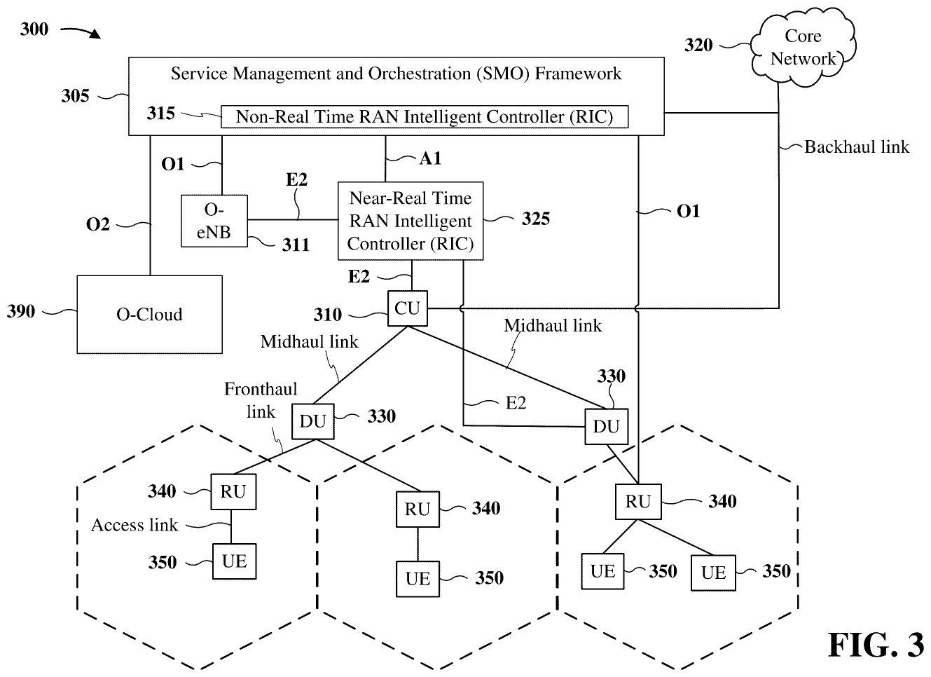

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

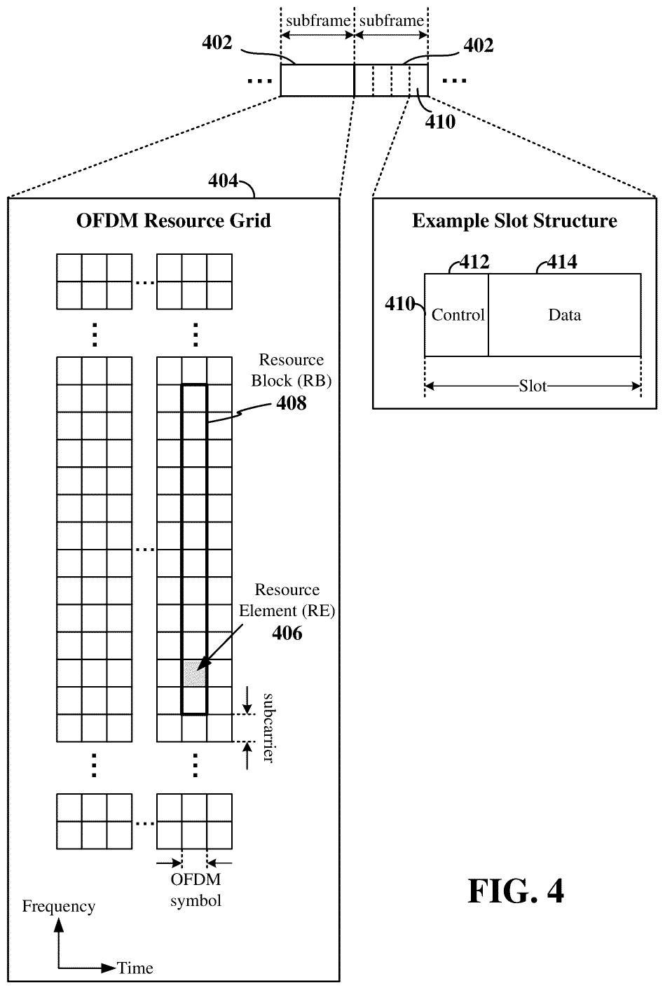

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a network entity (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a network entity) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

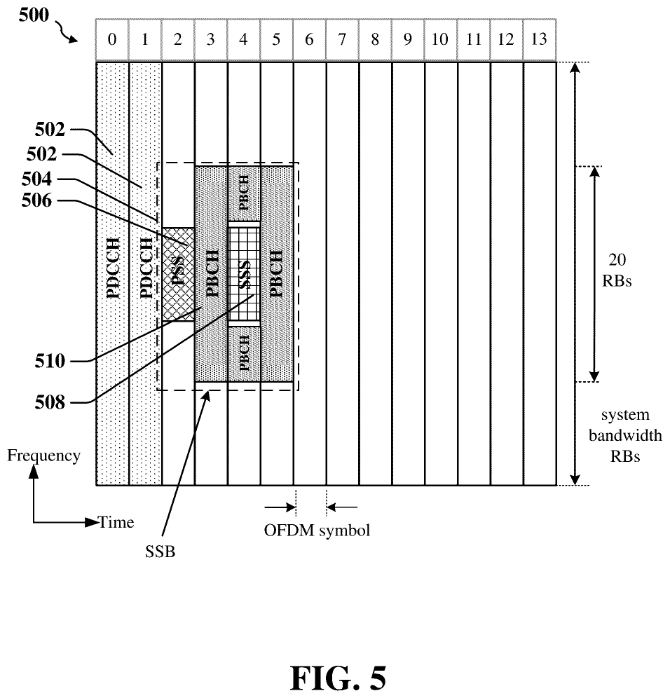

FIG. 5 illustrates an example 500 of various downlink channels within a subframe of a frame including channels used for initial access and synchronization. As shown in FIG. 5, a physical downlink control channel (PDCCH) 502 is transmitted in at least two symbols (e.g., symbol 0 and symbol 1) and may carry DCI within at least one control channel element (CCE), with each CCE including nine RE groups (REGs), and each RE group (REG) including four consecutive REs in an OFDM symbol. Additionally, FIG. 5 illustrates an exemplary synchronization signal block (SSB) 504 that may be periodically transmitted by a network entity (e.g., a gNB). The SSB 504 carries synchronization signals PSS 506 and SSS 508 and broadcast channels (PBCH) 510. In this example, the SSB 504 contains one PSS symbol (shown in symbol 2), one SSS symbol (shown in symbol 4) and two PBCH symbols (shown in symbols 3 and 5). The PSS and SSS combination may be used to identify physical cell identities. A UE uses the PSS to determine subframe/symbol timing and a physical layer identity. The SSS is used by a UE to determine a physical layer cell identity group number and radio frame timing. Based on the physical layer identity and the physical layer cell identity group number, the UE can determine a physical cell identifier (PCI). Also, based on the PCI, the UE can determine the locations of the aforementioned DMRS. The physical broadcast channel (PBCH), which carries a master information block (MIB), is logically grouped with the PSS and SSS to form the synchronization signal; i.e., the SSB 504. The MIB provides a number of RBs in the system bandwidth and a system frame number (SFN).

The PBCH in the SSB 504 includes the MIB carrying various system information (SI) including, for example, a cell barred indication, the subcarrier spacing, the system frame number, and scheduling information for a CORESET0. For example, the PBCH in the SSB 504 may include scheduling information indicating time-frequency resources allocated for the CORESET0. In some examples, the CORESET0 may be transmitted within the first four symbols (e.g., within a control region) of a slot. In addition, the CORESET0 carries a PDCCH with DCI that contains scheduling information for scheduling the SIB1. The SIB1 is carried within a physical downlink shared channel (PDSCH) within a data region of a slot. In addition, the SIB1 may be referred to as RMSI and includes, for example, a set of radio resource parameters providing network identification and configuration. For example, the set of radio resource parameters may include a bandwidth (e.g., number of BWPs) on which a UE may communicate with a network entity.

The MIB in the PBCH may include system information (SI), along with parameters for decoding a SIB (e.g., SIB1). Examples of SI transmitted in the MIB may include, but are not limited to, a subcarrier spacing, a system frame number, a configuration of a PDCCH control resource set (CORESET) (e.g., PDCCH CORESET0), and a search space for SIB1. Examples of SI transmitted in the SIB1 may include, but are not limited to, a random access search space, downlink configuration information, and uplink configuration information. The MIB and SIB1 together provide the minimum SI for initial access.

A brief discussion of an initial access procedure for a UE using the above information follows. As discussed above, a network entity may transmit synchronization signals (e.g., including PSS and SSS) in the network to enable UEs to synchronize with the BS, as well as SI (e.g., including a MIB, RMSI, and OSI) to facilitate initial network access. The BS may transmit the PSS, the SSS, and/or the MIB via SSBs over the PBCH and may broadcast the RMSI and/or the OSI over the PDSCH.

A UE attempting to access a RAN (e.g., the RAN 200 of FIG. 2) may perform an initial cell search by detecting a PSS from a BS (e.g., the PSS of a cell of the BS) of the RAN. The PSS may enable the UE to synchronize to period timing of the BS and may indicate a physical layer identity value assigned to the cell. The UE may also receive an SSS from the BS that enables the UE to synchronize on the radio frame level with the cell. The SSS may also provide a cell identity value, which the UE may combine with the physical layer identity value to identify the cell.

After receiving the PSS and SSS, the UE may receive the SI from the BS. The system information may take the form of the MIB and SIBs discussed above. The system information may include information that a UE can use to access the network such as downlink (DL) channel configuration information, uplink (UL) channel configuration information, access class information, and cell barring information, as well as other information. The MIB may include SI for initial network access and scheduling information for RMSI and/or OSI. After decoding the MIB, the UE may receive the RMSI and/or the OSI.

The SI includes information that enables a UE to determine how to conduct an initial access to a RAN. In some examples, the SIB2 includes random access configuration information (e.g., a RACH configuration) that indicates the resources that the UE is to use to communicate with the RAN during initial access. The random access configuration information may indicate, for example, the resources allocated by the RAN for a random access channel (RACH) procedure. For example, the RACH configuration may indicate the resources allocated by the network for the UE to transmit a physical random access channel (PRACH) preamble and to receive a random access response. In some examples, the RACH configuration identifies monitoring occasions (MOs) that specify a set of symbols (e.g., in a PRACH slot) that are scheduled by a network entity for the PRACH procedure. The RACH configuration may also indicate the size of a random access response window during which the UE is to monitor for a response to a PRACH preamble. The RACH configuration may further specify that the random access response window starts a certain number of sub-frames after the end of the PRACH preamble in some examples. After obtaining the MIB, the RMSI and/or the OSI, the UE may thus perform a random access procedure for initial access to the RAN.

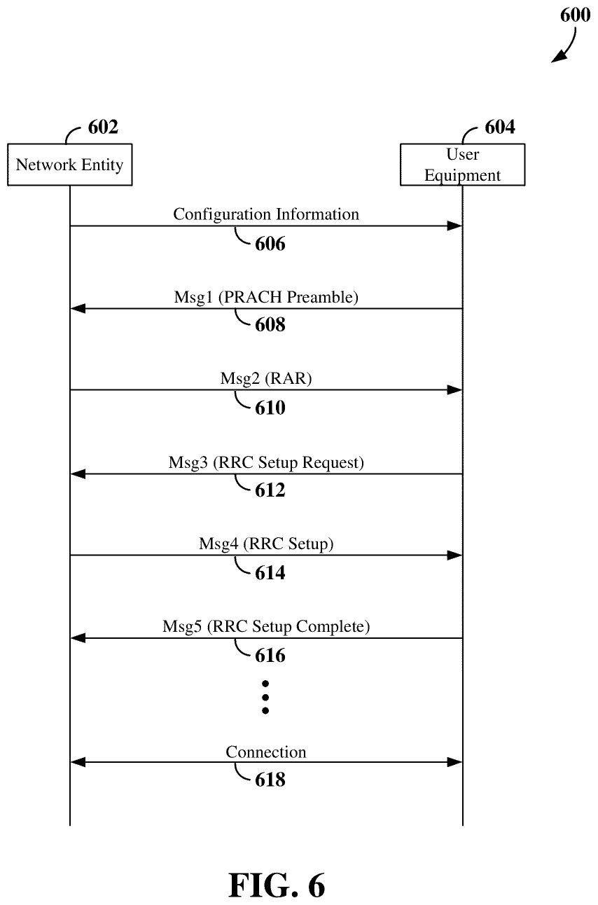

FIG. 6 is a signaling diagram 600 illustrating an example of signaling associated with a contention-based RACH procedure in a wireless communication system including a network entity (e.g., a base station) 602 and a user equipment 604. In some examples, the network entity 602 may correspond to any of the network entities, base stations, CUs, DUs, RUs, or scheduling entities shown in any of FIGS. 1, 2, 3, 8, 9, 11, 12, 13, and 16. In some examples, the user equipment 604 may correspond to any of the UEs or scheduled entities shown in any of FIGS. 1, 2, 3, 8, 9, 11, 12, 13, and 14.

At 606 of FIG. 6, the network entity 602 broadcasts configuration information that nearby devices (e.g., the user equipment 604) may use for a RACH procedure directed to the network entity 602. For example, the network entity 602 may broadcast the random access-related SI discussed above.

At 608 of FIG. 6, the user equipment 604 transmits a message 1 (which may be referred to as Msg1) of the RACH procedure to the network entity 602. In some examples, the Msg1 is a PRACH preamble. RACH Msg1 may be referred to as PRACH. As mentioned above, the user equipment 604 may transmit the PRACH preamble on resources specified by a RACH configuration included in SIB2.

At 610, the network entity 602 responds to the PRACH preamble with a message 2 (which may be referred to as Msg2) of the RACH procedure. The Msg2 may be referred to informally as a random access response (RAR). In some examples of 610, the network entity 602 transmits a DCI on a PDCCH, where the DCI schedules a PDSCH (e.g., the DCI specifies the resources for the PDSCH transmission). The network entity 602 then transmits the PDSCH which includes the RAR data such as, for example, an UL grant for the user equipment to transmit a message 3 (which may be referred to as Msg3) of the RACH procedure.

In some examples, the user equipment monitors for the RACH Msg2 on resources specified by the RACH configuration during the RAR window specified by the RACH configuration. For example, the user equipment may decode the DCI carried on the PDCCH and then decode the RAR carried on the PDSCH.

At 612, upon receiving all of the RAR information, the user equipment 604 transmits the Msg3 of the RACH procedure. In some examples, the RACH Msg3 is a radio resource control (RRC) Setup Request message.

At 614, the network entity 602 responds with a message 4 (which may be referred to as Msg4) of the RACH procedure. In some examples, the RACH Msg4 is an RRC Setup message (e.g., a contention resolution message).

At 616, the user equipment 604 responds with a message 5 (which may be referred to as Msg5) of the RACH procedure. In some examples, the RACH Msg5 is an RRC Setup Complete message. In some examples, if the user equipment 604 successfully decodes the RACH Msg 4, the transmission of RACH Msg5 may involve transmitting a PUCCH including a HARQ-ACK for the PDSCH data of RACH Msg4. In some examples, PUCCH frequency hopping may be used for this transmission of the RACH Msg5.

As indicated by 618, the network entity 602 and the user equipment 604 ultimately establish a connection and enter an active operational phase where data may be exchanged. For example, the network entity 602 may schedule the user equipment 604 for UL communication and/or DL communication.

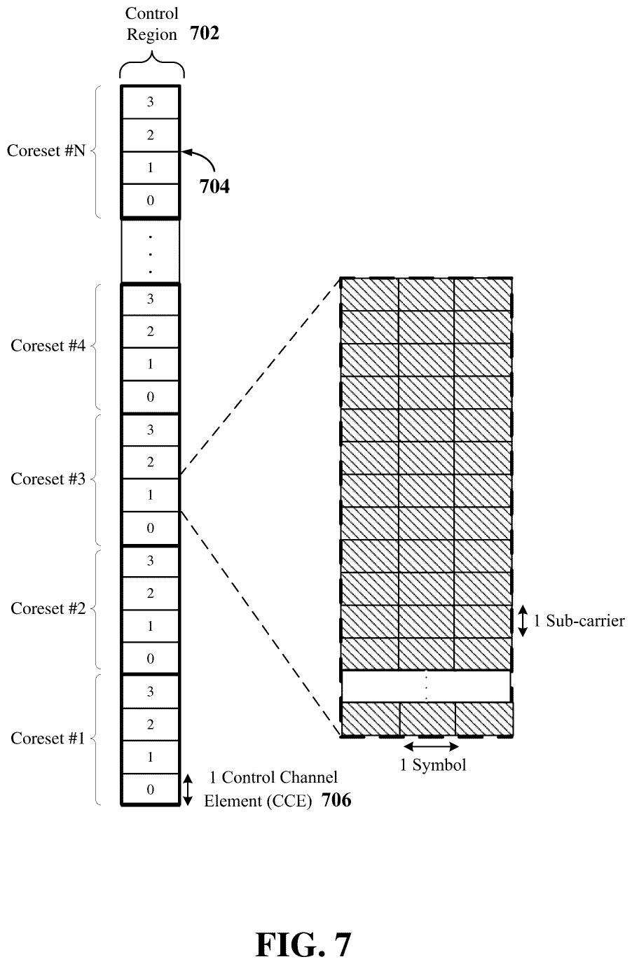

As mentioned above, a network entity may use a downlink control region of a slot to send PDCCH information to a UE. In some examples, the PDCCH information may be a scheduling DCI that schedules a downlink transmission to a UE, a scheduling DCI that schedules an uplink transmission by a UE, or a scheduling DCI that schedules some other transmission. In some examples, the PDCCH information may be a non-scheduling DCI (e.g., a DCI that carries information, but does not schedule a transmission). FIG. 7 describes example resource configurations that may be used to carry such PDCCH information.

FIG. 7 is a schematic illustration of an example of a downlink (DL) control region 702 of a slot according to some aspects. The DL control region 702 may correspond, for example, to the control region 412 of the slot 410 illustrated in FIG. 4. As discussed above, the DL control region 702 may carry a PDCCH that includes one or more DCIs.

The DL control region 702 includes a plurality of CORESETs 704 indexed as CORESET #1-CORESET #N. Each CORESET 704 includes a number of sub-carriers in the frequency domain and one or more symbols in the time domain. In the example of FIG. 7, each CORESET 704 includes at least one control channel element (CCE) 706 having dimensions in both frequency and time, sized to span across at least three OFDM symbols. A CORESET 704 having a size that spans across two or more OFDM symbols may be beneficial for use over a relatively small system bandwidth (e.g., 7 MHz). However, a one-symbol CORESET may be used in some scenarios.

In some examples, a network entity may configure a CORESET 704 for carrying group common control information or UE-specific control information, whereby the CORESET 704 may be used for transmission of a PDCCH including the group common control information or the UE-specific control information to one or more UEs. Each UE may be configured to monitor one or more CORESETs 704 for the UE-specific or group common control information (e.g., on a PDCCH).

In some examples, the PDCCH may be constructed from a variable number of CCEs, depending on the PDCCH format (e.g., aggregation level). Each PDCCH format (e.g., aggregation level) supports a different DCI length. In some examples, PDCCH aggregation levels of 1, 2, 4, 8, and 16 may be supported, corresponding to 1, 2, 4, 8, or 16 contiguous CCEs, respectively.

A bandwidth part (BWP) may be defined within a carrier bandwidth (CBW). According to some aspects, a BWP is a contiguous set of physical resource blocks (PRBs) on a given carrier. The contiguous set of PRBs may correspond to a contiguous set of CCEs. In some examples, a BWP corresponds to a set of 64 PRBs, which represent 648 subcarriers (i.e., 12 REs/REG×6 REGs/CCE×9 CCEs). A network entity may configure different sets of these CCEs as common CCEs or UE-specific CCEs.

In some examples, a CORESET may include 48 REGs in one set of eight CCEs. The eight CCEs may be grouped as a first DCI. The following relationships between CORESETs, BWPs, and search spaces are made with reference to some examples of NR; however, the following is an example and non-limiting and other relationships between CORESETs, BWPs, and search spaces (or their equivalents, for example in other radio technologies) are within the scope of the disclosure. In some examples, for a given UE, a network entity may configure up to five CORESETs in a BWP of a serving cell (e.g., a component carrier (CC)), including both common and UE-specific CORESETs. In addition, the network entity may configure up to four BWPs per serving cell, with one or more of the BWPs active at a given time. The resource elements of a CORESET may be mapped to one or more CCEs.

For uplink transmissions, a 5G NR uplink allows for uplink intracell orthogonality so that the uplink transmissions received from different devices within a cell do not interfere with each other. To enable such uplink orthogonality, the uplink slot boundaries for a given numerology are (approximately) time aligned at the network entity. To ensure such receiver-side time alignment, a network entity may transmit a timing advance (TA) signal or indication to a UE so that the UE may adjust its uplink timing accordingly.

Generally, timing advance is a negative offset applied at a wireless device (e.g., a UE) between the start of a downlink (DL) symbol (or subframe) as observed by the device and the start of a symbol in the uplink (UL). By controlling the offset appropriately for each device, the network (e.g., a network entity such as a gNB) may control the timing of the signals received at the network entity from the various devices (UEs) in a cell being served. Devices located far from the network entity encounter a longer propagation delay, and, therefore, should start their uplink transmissions somewhat in advance, compared to devices located closer to the network entity that encounter a shorter propagation delay.

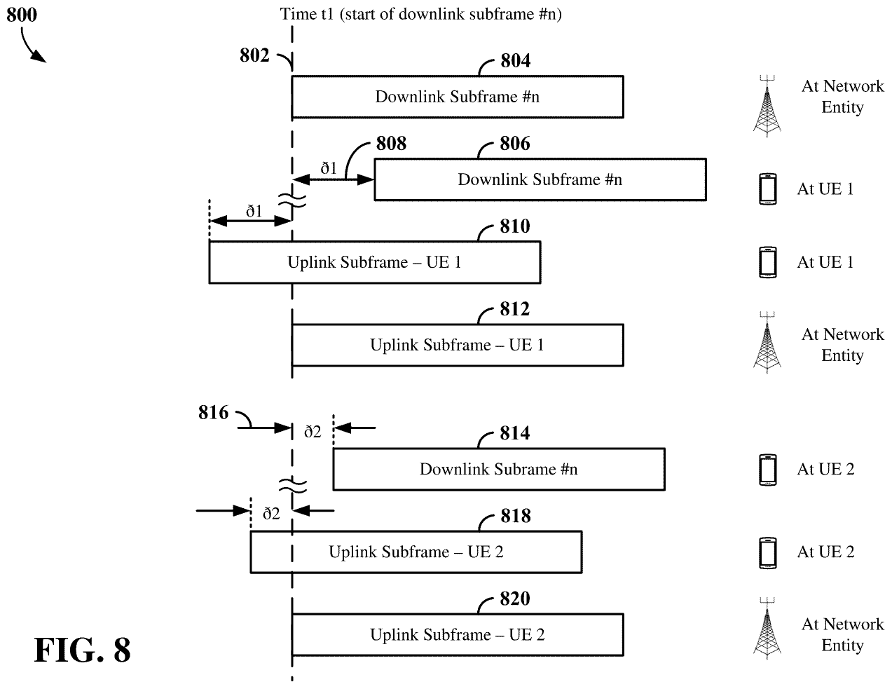

FIG. 8 illustrates an example 800 of downlink and uplink timing. In this example, a first UE (UE 1) is located further from a network entity (e.g., a gNB) than a second UE (UE 2). Time-aligned downlink transmissions and uplink transmissions are illustrated relative to a time t1 802 that represents a subframe boundary at the network entity.

As represented by a downlink subframe 804 (designated as downlink subframe #n in this example), transmission of a downlink subframe at the network entity starts at the time t1 802. A downlink subframe 806 represents the delayed reception of the downlink subframe 804 at the first UE (UE 1). As indicated, the subframe 806 is received at the first UE (UE 1) after a propagation delay δ1 808.

In some aspects, it may be desired that uplink transmissions be received at the network entity time aligned with the network entity's subframe boundary. To this end, based on a timing advance command received from the network entity, the first UE (UE 1) may transmit an uplink subframe 810 at a time that precedes the network entity's subframe boundary by the propagation delay δ1. An uplink subframe 812 represents the delayed reception of the uplink subframe 810 at the network entity. As indicated, this uplink subframe is received time aligned with the network entity's subframe boundary. For convenience, the transmission of the uplink subframe is depicted relative to the time t1 802. It should be appreciated, however, that in a half-duplex system the relative subframe boundary for the uplink transmission would be later in time than the time t1 802.

FIG. 8 further illustrates that the propagation delay 82 from the network entity to the second UE (UE 2) is shorter than the propagation delay 81 due to the second UE (UE 2) being closer to the network entity than the first UE (UE 1). A downlink subframe 814 represents the delayed reception of the downlink subframe 804 at the second UE (UE 2). As indicated, the subframe 814 is received at the second UE (UE 2) after a propagation delay δ2 816.

Based on a timing advance command received from the network entity, the second UE (UE 2) may transmit an uplink subframe 818 at a time that precedes the network entity's subframe boundary by the propagation delay δ2. An uplink subframe 820 represents the delayed reception of the uplink subframe 818 at the network entity. As indicated, this uplink subframe is received time aligned with the network entity's subframe boundary. For convenience, the transmission of the uplink subframe is again depicted relative to the time t1 802. It should be appreciated, however, that in a half-duplex system the relative subframe boundary for the uplink transmission would be later in time than the time t1 802.

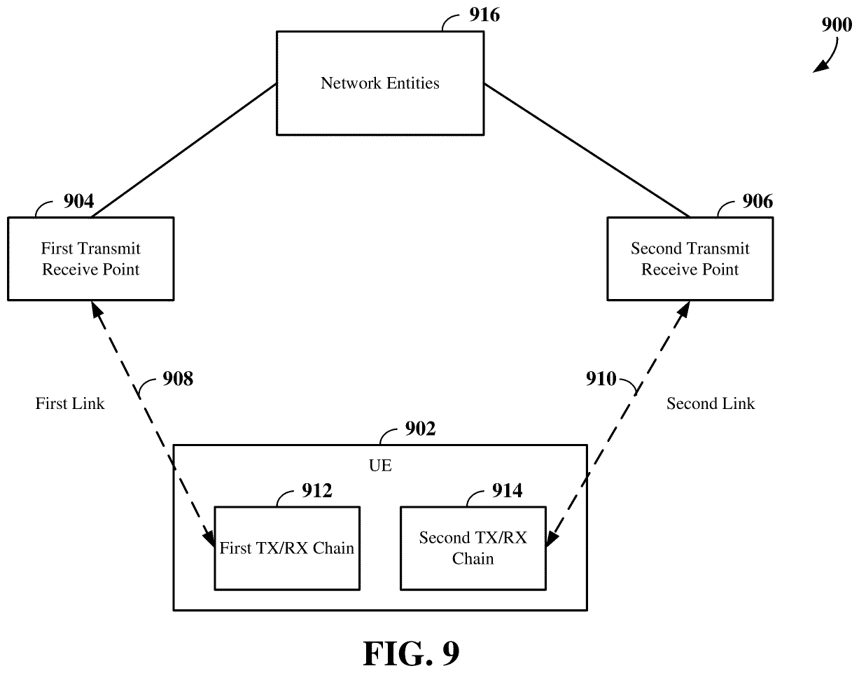

As mentioned above, a UE may communicate with a network via one or more transmit receive points (TRPs). FIG. 9 illustrates a communication system 900 where a user equipment (UE) 902 communicates with at least one TRP 904 and at least one TRP 906 via a first link 908 and a second link 910, respectively. For example, a first transmit receive (TX/RX) chain 912 of the UE 902 may communicate with the first TRP 904 via the first link 908 (e.g., an uplink and a downlink). In addition, a second TX/RX chain 914 of the UE 902 may communicate with the second TRP 906 via the second link 910 (e.g., an uplink and a downlink). In different implementations, the TRP 904 may be a single TRP or a set of TRPs. Similarly, the TRP 906 may be a single TRP or a set of TRPs. Also, the TRPs 904 and 904 may be associated with the same cell or different cells.

In some aspects, a TRP may refer to a physical entity that incorporates RU functionality for a particular physical cell. This functionality may be similar in one or more aspects to (or incorporated into) the RU functionality of a NodeB, an eNodeB, a gNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), or some other similar entity.

As discussed above, the TRPs 904 and 906 of FIG. 9 may operate under the control of one or more network entities 916. For example, the TRPs 904 and 906 may be controlled by a single DU. As another example, the TRP 904 may be controlled by a first DU and the TRP 906 may be controlled by a second DU. Also, the TRPs 904 and 906 may be controlled by a single CU or different CUs.

A UE operating in a multi-TRP scenario (e.g., as shown in FIG. 9) may be scheduled in different ways in different implementations. In some examples, a single DCI is used to schedule an uplink or downlink transmission for the UE via the TRPs. For example, the DCI may schedule a first set of MIMO layers on a first TRP and schedule a second set of MIMO layers on a second TRP.

In other examples, multiple DCIs may be used for a multi-TRP (mTRP) scenario. In such a multi-DCI (mDCI) scenario, a first DCI may be used to schedule an uplink or downlink transmission for the UE via the first TRP, while a second DCI may be used to schedule an uplink or downlink transmission for the UE via the second TRP.

In some wireless communication systems, a multi-TRP scenario may be supported through the use of control resource set pools. Here, the control resource sets (e.g., five CORESETs) allocated for a given BWP and component carrier (CC) may be grouped into different groups according to a control resource set pool index (CORESETPoolIndex). For example, a first subset of the control resource sets (e.g., two CORESETs with CORESET ID 1 and CORESET ID 2, respectively) may be assigned to a CORESETPoolIndex 0 and a second subset of the control resource sets (e.g., two CORESETs with CORESET ID 3 and CORESET ID 4, respectively) may be assigned to a CORESETPoolIndex 1. In some aspects, a CORESETPoolIndex is effectively a TRP ID (e.g., CORESETPoolIndex 0 may correspond to TRP 1 and CORESETPoolIndex 1 may correspond to TRP 2) since the presence of different TRPs may be transparent to a UE.

In some examples, channels/signals (e.g., PUCCH, PUSCH, SRS, etc.) can be associated with a CORESETPoolIndex value. For example, when a UE receives a DCI on a CORESET associated with CORESETPoolIndex 0, the UE may be able to determine that the DCI is from TRP 1. As another example, an RRC configuration may be used to associate a particular channel/signal with a particular CORESETPoolIndex value.

Thus, in a multi-DCI scenario involving multiple TRP transmissions, a UE may differentiate the different TRPs based on the CORESETPoolIndex. In some examples, a UE may be configured with multiple DCIs and multiple TRPs in a given CC through the use of a higher layer parameter PDCCH-Config that contains two different values of CORESETPoolIndex in CORESETs for the active BWP of a serving cell.

In some examples (e.g., an intra-cell scenario), different TRPs may be associated with the same PCI. For example, different panels of the same cell or network entity may use the same PCI. As another example, different remote radio heads of the same cell or network entity may use the same PCI.

In some examples (e.g., an intra-cell scenario), different TRPs may be associated with different PCIs. For example, the network may configure additional PCI indices (e.g., AdditionalPCIIndex-r17) for a UE. In this case, from the UE's perspective, a multi-TRP is defined in a given serving cell, but the UE might only be aware of one PCI (the PCI that the UE acquired during its initial cell search).

In some examples, when the uplink (UL) for a UE is not synchronized, a RACH procedure can be triggered for UL timing alignment. For example, the network may send a PDCCH message to a UE that orders the UE to perform a RACH procedure and thereby obtain timing advance information from the network. In some examples, this RACH procedure may be either a contention free random access (CFRA) procedure or a contention based random access (CBRA) procedure.

In some examples, such a PDCCH order may use DCI format 1_0. For example, if the CRC of the DCI format 1_0 is scrambled by C-RNTI and the frequency domain resource assignment field is all ones, the DCI format 1_0 may be deemed to be for a random access procedure initiated by a PDCCH order, with the remaining fields set as described below. In this case, the Random Access Preamble index (6 bits) field is set according to ra-PreambleIndex. For the UL/SUL indicator (1 bit) field, if the value of the Random Access Preamble index is not all zeros and if the UE is configured with supplementaryUplink in ServingCellConfig in the cell, this field indicates which UL carrier in the cell the UE is to use to transmit the PRACH. Otherwise, this field is reserved. For the SS/PBCH index (6 bits) field, if the value of the Random Access Preamble index is not all zeros, this field indicates the SS/PBCH to be used to determine the RACH occasion for the PRACH transmission. Otherwise, this field is reserved. For the PRACH Mask index (4 bits) field, if the value of the Random Access Preamble index is not all zeros, this field indicates the RACH occasion associated with the SS/PBCH indicated by the SS/PBCH index for the PRACH transmission. Otherwise, this field is reserved. The DCI also includes twelve reserved bits for operation in a cell with shared spectrum channel access, or ten reserved bits otherwise.

When a CFRA procedure is triggered by a PDCCH order, the random access preamble index is set to a non-zero value (the index is not set to all zeros). In this case, the SSB index or PRACH occasion is indicated by the SS/PBCH index and the PRACH Mask index field in the PDCCH.

When a CBRA procedure is triggered by a PDCCH order, the random access preamble index in the PDCCH is set to all zeros, and the uplink/supplementary uplink (UL/SUL) indicator, the synchronization signal/physical broadcast channel (SS/PBCH) index, and the PRACH Mask index fields in the PDCCH order are set as reserved. In this case, the UE will select an SSB for the CBRA procedure based on a reference signal received power (RSRP) measurement on the SSBs for a cell. For example, if at least one of the SSBs associated with an SS-RSRP is above a threshold (e.g., rsrp-ThresholdSSB), the UE will select one of the SSBs with an SS-RSRP above the threshold. Otherwise, the UE will select any of the SSBs associated with the cell. In some examples, the threshold may be configured by RRC per BWP per CC.

In a multi-DCI based multi-TRP scenario, two TAs may be used, for example, because the propagation delays from a UE to different TRPs may be different. Thus, the UE may be configured to use a first TA value for a first TRP and a second TA value for a second TRP in some examples.

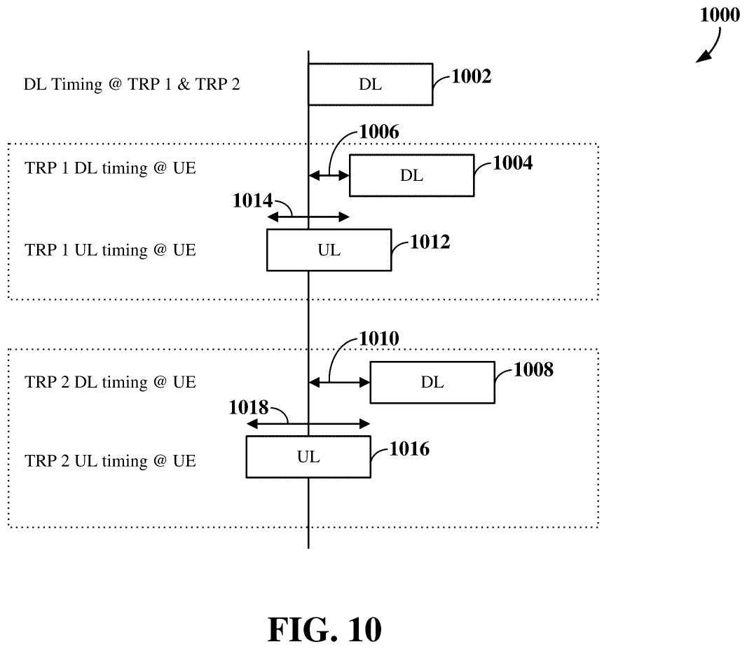

The diagram 1000 of FIG. 10 illustrates an example of uplink (UL) timing and downlink (DL) timing between a UE and two TRPs (TRP 1 and TRP 2). A first message 1002 illustrates the DL timing at TRP 1 and TRP 2. As indicated, the DL timing for TRP 1 and TRP 2 may be synchronized in this example (while it may not be synchronized in other examples).

A second message 1004 illustrates the DL timing associated with TRP 1 at the UE. The propagation delay from TRP 1 to the UE is represented by a line 1006. A third message 1008 illustrates the DL timing associated with TRP 2 at the UE. The propagation delay from TRP 2 to the UE is represented by a line 1010. As shown in FIG. 10, the propagation delays represented by lines 1006 and 1010 are different.

With respect to the uplink timing, a fourth message 1012 illustrates the UL timing associated with TRP 1 at the UE. Here, to ensure that the fourth message 1012 (an UL message) is received at TRP 1 at the proper time, the UE may send the fourth message 1012 to TRP 1 a certain amount of time (represented by a line 1014) prior to the second message 1004 (the DL message). A fifth message 1016 illustrates the UL timing associated with TRP 2 at the UE. Here, to ensure that the fifth message 1016 (an UL message) is received at TRP 2 at the proper time, the UE may send the fifth message 1016 to TRP 2 a certain amount of time (represented by a line 1018) prior to the third message 1008 (the DL message). It may thus be seen that the UE may use different timing advance values when transmitting to the different TRPs.

For a multiple DCI multiple TRP (mDCI mTRP) scenario, when the UL is not synchronized for a given TRP (e.g., a TRP corresponding to a CORESETPoolIndex value for intra-cell mTRP or to an additional PCI for inter-cell mTRP), a CBRA procedure may be triggered for that TRP. The CBRA may be triggered by a PDCCH order as discussed above, or the CBRA may be triggered by a UE (e.g., upon expiration of a timing alignment timer).

The disclosure relates in some aspects determining the random access resource (e.g., the SSB resource) to be used for a CBRA associated with a given TRP. In some aspects, this involves the UE identifying the TRP associated with the triggered CBRA procedure. Two examples are described below for an intra-cell scenario and an inter-cell scenario, respectively.

In the first example (e.g., an intra-cell scenario), the association between a CBRA and a CORESETPoolIndex value is defined by a rule or configured by an RRC message. For a CBRA triggered for a given CORESETPoolIndex value, the UE (e.g., a MAC entity of the UE) selects an SSB from the SSBs associated with the given CORESETPoolIndex value.

Here, if at least one of the SSBs associated with the given CORESETPoolIndex value has a measured SS-RSRP above a threshold, the UE selects one of the SSBs associated with the given CORESETPoolIndex value that has a measured SS-RSRP above the threshold. Otherwise, if none of the SSBs associated with the given CORESETPoolIndex value has a measured SS-RSRP above the threshold, the UE selects any SSB from the SSBs associated with the given CORESETPoolIndex value.

Different thresholds may be used in different examples. In some examples, a common threshold may be configured by an RRC message and applied for each CORESETPoolIndex value. In some examples, different thresholds may be configured for different CORESETPoolIndex values, whereby each threshold is associated with a corresponding CORESETPoolIndex value.

After selecting the SSB, the UE (e.g., the MAC entity) selects a PRACH preamble randomly with equal probability from the PRACH preambles associated with the selected SSB. In addition, the UE identifies the PRACH occasion associated with the selected SSB. After selecting the PRACH preamble, the UE MAC entity instructs the UE PHY layer to transmit the PRACH preamble using the selected PRACH occasion.

If a CBRA is triggered by a PDCCH order, the UE (e.g., the UE PHY) can determine the association between the CBRA and a CORESETPoolIndex value using at least one of the examples that follow. In some examples, the UE determines the association between the CBRA and a CORESETPoolIndex value based on the CORESETPoolIndex value of the CORESET in which the PDCCH order is received.

In some examples, the UE determines the association between the CBRA and a CORESETPoolIndex value based on the transmission configuration indicator (TCI) state of the CORESET in which the PDCCH order is received. In this case, a given TCI state is associated with a corresponding CORESETPoolIndex value (e.g., a first subset of the TCI states is associated with CORESETPoolIndex=0, and a second subset of the TCI states is associated with CORESETPoolIndex=1).

In some examples, the UE determines the association between the CBRA and a CORESETPoolIndex value based an indication included in the PDCCH order. As discussed above, for CBRA, some of the fields of the PDCCH order are designated as reserved.

In some examples, the UL/SUL indicator in the PDCCH order may be reused to indicate the CORESETPoolIndex value for the CBRA. For example, if the value of the Random Access Preamble index is all zeros, the UL/SUL indicator field may indicate the CORESETPoolIndex value of the triggered CBRA.

In some examples, the existing reserved bits in PDCCH order may be reused to indicate the CORESETPoolIndex value for the CBRA. For example, one bit of the reserved bits may be used to indicate the CORESETPoolIndex value of the triggered CBRA.

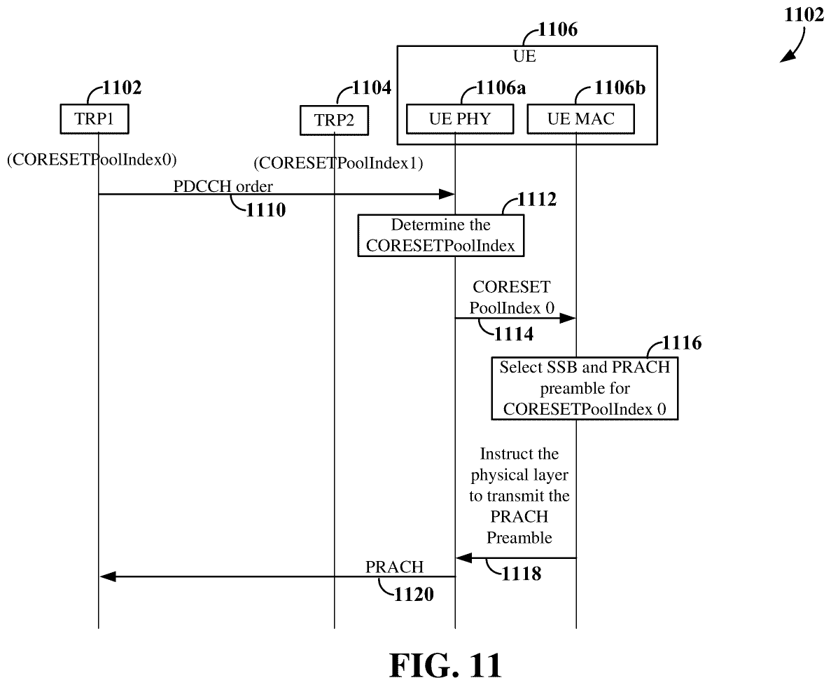

After determining the CORESETPoolIndex associated with the CBRA, the UE PHY may pass the CORESETPoolIndex value to the UE MAC layer so that the UE MAC layer may select random access resource for the CORESETPoolIndex value as illustrated in FIG. 11. FIG. 11 is a signaling diagram 1100 illustrating an example of signaling associated with random access resource selection for an intra-cell scenario where a contention-based random access procedure is triggered by a physical downlink control channel order in a wireless communication system including a first TRP 1102, a second TRP 1104, and a user equipment (UE) 1106 including a UE PHY entity 1106a and a UE MAC entity 1106b. In some examples, the first TRP 1102 and the second TRP 1104 may correspond to any of the network entities, base stations, CUs, DUs, RUs, or scheduling entities shown in any of FIGS. 1, 2, 3, 6, 8, 9, 12, 13, and 17. In some examples, the user equipment 1106 may correspond to any of the UEs or scheduled entities shown in any of FIGS. 1, 2, 3, 6, 8, 9, 12, 14, and 14.

At 1110 of FIG. 11, the first TRP 1102 transmits a PDCCH order to the user equipment 1106. In this example, the PDCCH order instructs the user equipment 1106 to perform a CBRA procedure.

At 1112, the UE PHY entity 1106a determines the CORESETPoolIndex value associated with the CBRA procedure. For example, the UE PHY entity 1106a may determine the association between the CBRA and a CORESETPoolIndex value based on the CORESETPoolIndex value of the CORESET in which the PDCCH order is received, based on the TCI state of the CORESET in which the PDCCH order is received, or based an indication included in the PDCCH order. At 1114, the UE PHY entity 1106a sends an indication of the identified CORESETPoolIndex value to the UE MAC entity 1106b.

At 1116, the UE MAC entity 1106b selects one of the SSBs associated with the identified CORESETPoolIndex (e.g., based on the SS-RSRP threshold as discussed above). In addition, the UE MAC entity 1106b randomly selects one of the PRACH preamble associated with the selected SSB, and identifies a RACH occasion associated with the selected SSB.

At 1118, the UE MAC entity 1106b instructs the UE PHY entity 1106a to transmit the selected PRACH preamble on the identified RACH occasion. Thus, at 1120, the UE PHY entity 1106a transmits the selected PRACH preamble to the first TRP 1102.

If a CBRA is triggered by the UE (e.g., the MAC entity), the UE can determine the association between the CBRA and a CORESETPoolIndex value based on the CORESETPoolIndex value associated with the timeAlignmentTimer. For example, if the timeAlignmentTimer associated with a given CORESETPoolIndex value is expired, the UE MAC entity may trigger a CBRA for that CORESETPoolIndex value.

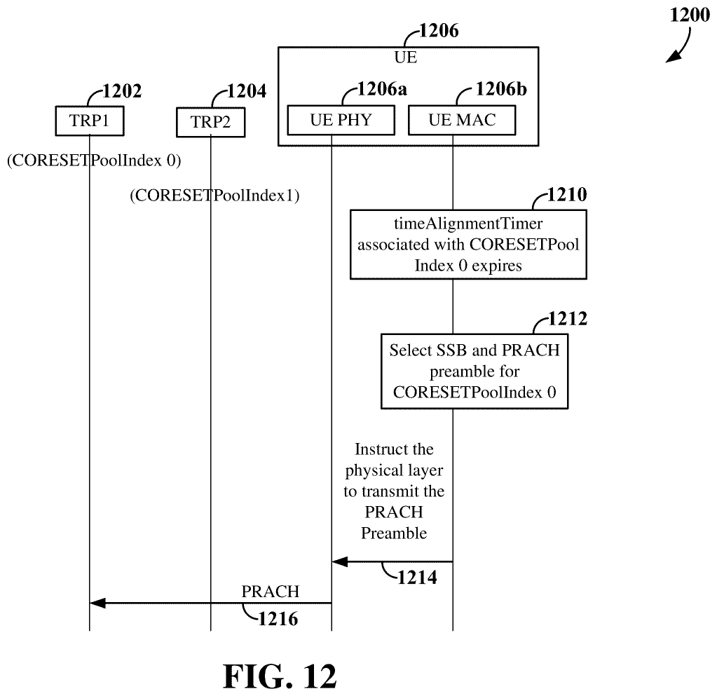

Since this CBRA is triggered by the UE MAC, there no signaling exchange between UE PHY and MAC layer associated with the selection of the SSB as illustrated in FIG. 12. FIG. 12 is a signaling diagram 1200 illustrating an example of signaling associated with random access resource selection for an intra-cell scenario where a contention-based random access procedure is triggered by a user equipment in a wireless communication system including a first TRP 1202, a second TRP 1204, and a user equipment (UE) 1206 including a UE PHY entity 1206a and a UE MAC entity 1206b. In some examples, the first TRP 1202 and the second TRP 1204 may correspond to any of the network entities, base stations, CUs, DUs, RUs, or scheduling entities shown in any of FIGS. 1, 2, 3, 6, 8, 9, 11, 13, and 17. In some examples, the user equipment 1206 may correspond to any of the UEs or scheduled entities shown in any of FIGS. 1, 2, 3, 6, 8, 9, 11, 13, and 14.

At 1210 of FIG. 12, the timing alignment timer associated with a CORESETPoolIndex expires. At 1212, the UE MAC entity 1206b selects one of the SSBs associated with this CORESETPoolIndex (e.g., based on the SS-RSRP threshold as discussed above). In addition, the UE MAC entity 1206b randomly selects one of the PRACH preamble associated with the selected SSB, and identifies a RACH occasion associated with the selected SSB.

At 1214, the UE MAC entity 1206b instructs the UE PHY entity 1206a to transmit the selected PRACH preamble on the identified RACH occasion. Thus, at 1216, the UE PHY entity 1206a transmits the selected PRACH preamble to the first TRP 1202.

In the second example (e.g., the inter-cell scenario) mentioned above, the SSBs associated with each additional PCI can be configured by RRC. For a CBRA triggered for an additional PCI, the UE selects an SSB among the SSBs associated with the additional PCI (e.g., a PCI that has not been activated).

If at least one of the SSBs associated with the additional PCI has a measured SS-RSRP that is above a threshold, the UE selects one of the SSBs associated with the additional PCI that has a measured SS-RSRP above the threshold. Otherwise, if none of the SSBs associated with the additional PCI have a measured SS-RSRP above the threshold, the UE selects any one of the SSBs associated with the additional PCI.

After selecting the SSB, the UE (e.g., a MAC entity) selects a PRACH Preamble randomly with equal probability from the PRACH Preambles associated with the selected SSB. After selecting the PRACH preamble, the UE MAC instruct the UE PHY layer to transmit the PRACH preamble using the PRACH occasion associated with the selected SSB.

Different thresholds may be used in different examples. In some examples, an existing threshold (e.g., rsrp-ThresholdSSB) may be used for both the serving cell PCI and any additional PCIs. In this case, a single threshold is applied for both intra-cell and inter-cell mTRP. In some examples, an additional threshold is configured by an RRC message and applied for each additional PCI. In this case, a separate threshold is used for the serving cell TRP verses the non-serving cell TRPs, while for all non-serving cell TRPs, a single threshold is used. In some examples, multiple thresholds are configured by RRC and each threshold is associated with an additional PCI. In this case, separate thresholds are used for non-serving cell TRPs.

If a CBRA is triggered by a PDCCH order, the UE can determine the association between the CBRA and an additional PCI based on an indication in the PDCCH order In some examples, some of the reserved bits in the PDCCH order are reused to indicate the additional PCI associated with the CBRA. In some examples, the SS/PBCH index or PRACH Mask index field is reused to indicate the additional PCI associated with the CBRA. For example, if the value of the Random Access Preamble index is all zeros, some of the bits (e.g., least significant bits (LSBs) or most significant bits (MSBs)) of the SS/PBCH index field or the PRACH Mask index field may indicate the additional PCI associated with the CBRA.

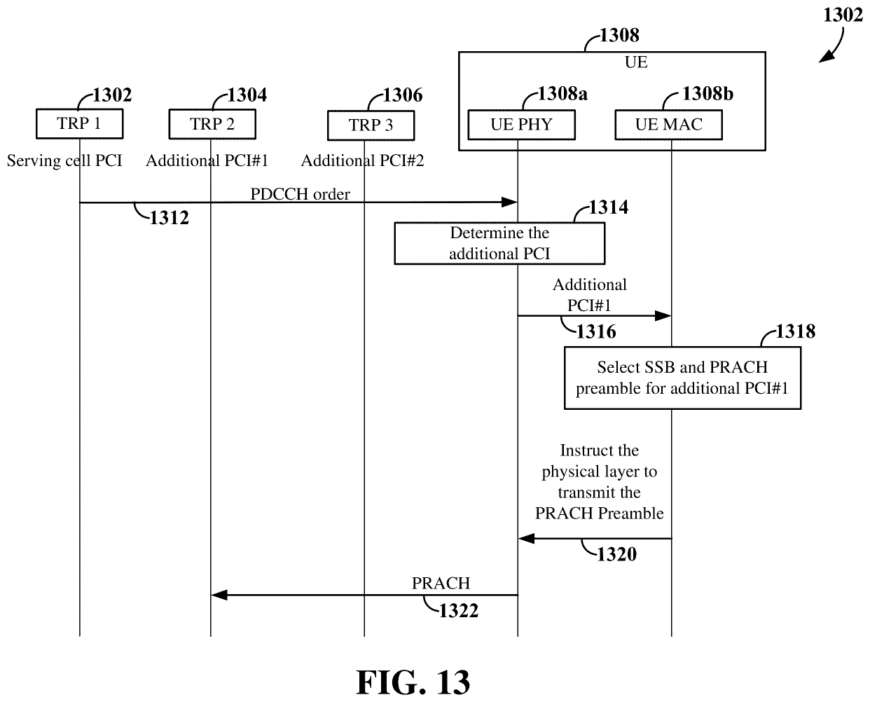

FIG. 13 is a signaling diagram 1300 illustrating an example of signaling associated with random access resource selection for an inter-cell scenario where a contention-based random access procedure is triggered by a physical downlink control channel order in a wireless communication system including a first TRP 1302, a second TRP 1304, a third TRP 1306, and a user equipment (UE) 1308 including a UE PHY entity 1308a and a UE MAC entity 1308b. In some examples, the first TRP 1302, the second TRP 1304, and the third TRP 1306 may correspond to any of the network entities, base stations, CUs, DUs, RUs, or scheduling entities shown in any of FIGS. 1, 2, 3, 6, 8, 9, 11, 12, and 17. In some examples, the user equipment 1308 may correspond to any of the UEs or scheduled entities shown in any of FIGS. 1, 2, 3, 6, 8, 9, 11, 12, and 14.

At 1312 of FIG. 13, the first TRP 1302 transmits a PDCCH order to the user equipment 1308. In this example, the PDCCH order instructs the user equipment 1308 to perform a CBRA procedure. In some examples, the PDCCH order may be transmitted from the TRP that is associated with the additional PCI indicated in the PDCCH order which is not shown in FIG. 13.

At 1314, the UE PHY entity 1308a determines the PCI associated with the CBRA procedure. For example, the UE PHY entity 1308a may determine the association between the CBRA and a PCI based on an indication included in the PDCCH order. At 1316, the UE PHY entity 1308a sends an indication of the identified PCI to the UE MAC entity 1308b.

At 1318, the UE MAC entity 1308b selects one of the SSBs associated with the identified PCI (e.g., based on the SS-RSRP threshold as discussed above). In addition, the UE MAC entity 1308b randomly selects one of the PRACH preamble associated with the selected SSB, and identifies a RACH occasion associated with the selected SSB.

At 1320, the UE MAC entity 1308b instructs the UE PHY entity 1308a to transmit the selected PRACH preamble on the identified RACH occasion. Thus, at 1322, the UE PHY entity 1308a transmits the selected PRACH preamble to the second TRP 1304.

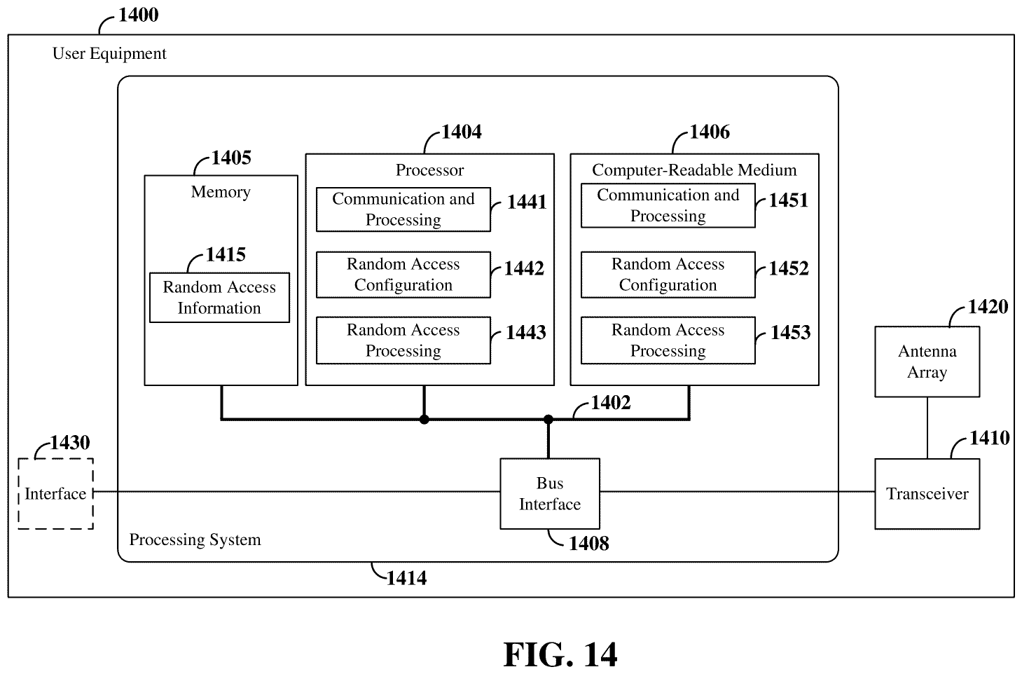

FIG. 14 is a block diagram illustrating an example of a hardware implementation for a UE 1400 employing a processing system 1414. For example, the UE 1400 may be a device configured to wirelessly communicate with a network entity, as discussed in any one or more of FIGS. 1-13. In some implementations, the UE 1400 may correspond to any of the UEs or scheduled entities shown in any of FIGS. 1, 2, 3, 6, 8, 9, 11, 12, and 13.

In accordance with various aspects of the disclosure, an element, or any portion of an element, or any combination of elements may be implemented with the processing system 1414. The processing system 1414 may include one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in a UE 1400, may be used to implement any one or more of the processes and procedures described herein.

The processor 1404 may in some instances be implemented via a baseband or modem chip and in other implementations, the processor 1404 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402, a transceiver 1410 and an antenna array 1420 and between the bus 1402 and an interface 1430. The transceiver 1410 provides a communication interface or means for communicating with various other apparatus over a wireless transmission medium. The interface 1430 provides a communication interface or means of communicating with various other apparatuses and devices (e.g., other devices housed within the same apparatus as the UE 1400 or other external apparatuses) over an internal bus or external transmission medium, such as an Ethernet cable. Depending upon the nature of the apparatus, the interface 1430 may include a user interface (e.g., keypad, display, speaker, microphone, joystick). Of course, such a user interface is optional, and may be omitted in some examples, such as an IoT device.

The processor 1404 is responsible for managing the bus 1402 and general processing, including the execution of software stored on the computer-readable medium 1406. The software, when executed by the processor 1404, causes the processing system 1414 to perform the various functions described below for any particular apparatus. The computer-readable medium 1406 and the memory 1405 may also be used for storing data that is manipulated by the processor 1404 when executing software. For example, the memory 1405 may store random access information 1415 (e.g., random access resource information) used by the processor 1404 for the communication operations described herein.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1406.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

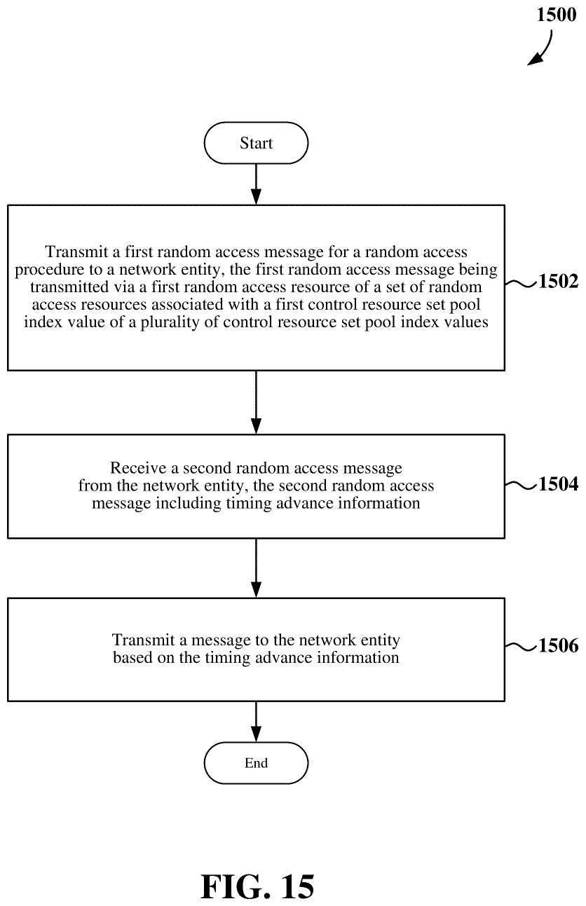

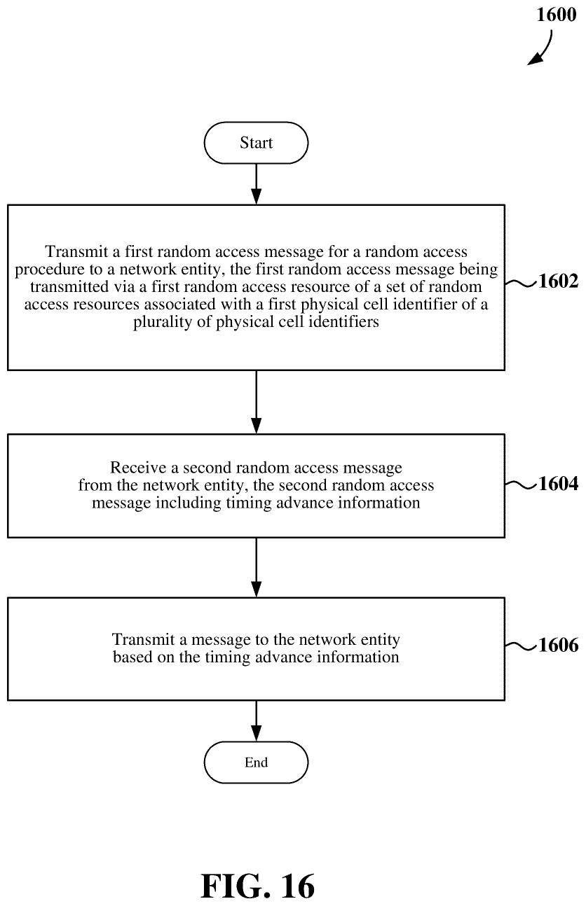

The UE 1400 may be configured to perform any one or more of the operations described herein (e.g., as described above in conjunction with FIGS. 1-13 and as described below in conjunction with FIGS. 15-16). In some aspects of the disclosure, the processor 1404, as utilized in the UE 1400, may include circuitry configured for various functions.

The processor 1404 may include communication and processing circuitry 1441. The communication and processing circuitry 1441 may be configured to communicate with a network entity, such as a gNB. The communication and processing circuitry 1441 may be configured to communicate with a network entity and one or more other wireless communication devices over a common carrier shared between a cellular (e.g., Uu) interface and a sidelink (e.g., PC5) interface. The communication and processing circuitry 1441 may include one or more hardware components that provide the physical structure that performs various processes related to wireless communication (e.g., signal reception and/or signal transmission) as described herein. The communication and processing circuitry 1441 may further include one or more hardware components that provide the physical structure that performs various processes related to signal processing (e.g., processing a received signal and/or processing a signal for transmission) as described herein. In some examples, the communication and processing circuitry 1441 may include two or more transmit/receive chains (e.g., one chain to communicate with a network entity and another chain to communicate with a sidelink device). The communication and processing circuitry 1441 may further be configured to execute communication and processing software 1451 included on the computer-readable medium 1406 to implement one or more functions described herein.

In some implementations where the communication involves receiving information, the communication and processing circuitry 1441 may obtain information from a component of the UE 1400 (e.g., from the transceiver 1410 that receives the information via radio frequency signaling or some other type of signaling suitable for the applicable communication medium), process (e.g., decode) the information, and output the processed information. For example, the communication and processing circuitry 1441 may output the information to another component of the processor 1404, to the memory 1405, or to the bus interface 1408. In some examples, the communication and processing circuitry 1441 may receive one or more of signals, messages, other information, or any combination thereof. In some examples, the communication and processing circuitry 1441 may receive information via one or more channels. In some examples, the communication and processing circuitry 1441 may receive one or more of signals, messages, SCIs, feedback, other information, or any combination thereof. In some examples, the communication and processing circuitry 1441 may receive information via one or more of a PSCCH, a PSSCH, a PSFCH, some other type of channel, or any combination thereof. In some examples, the communication and processing circuitry 1441 may include functionality for a means for receiving. In some examples, the communication and processing circuitry 1441 may include functionality for a means for decoding. In some examples, the communication and processing circuitry 1441 and/or the transceiver 1410 may include functionality for a means for receiving a message.

In some implementations where the communication involves sending (e.g., transmitting) information, the communication and processing circuitry 1441 may obtain information (e.g., from another component of the processor 1404, the memory 1405, or the bus interface 1408), process (e.g., encode) the information, and output the processed information. For example, the communication and processing circuitry 1441 may output the information to the transceiver 1410 (e.g., that transmits the information via radio frequency signaling or some other type of signaling suitable for the applicable communication medium). In some examples, the communication and processing circuitry 1441 may send one or more of signals, messages, other information, or any combination thereof. In some examples, the communication and processing circuitry 1441 may send information via one or more channels. In some examples, the communication and processing circuitry 1441 may send one or more of signals, messages, feedback, other information, or any combination thereof. In some examples, the communication and processing circuitry 1441 may send information via one or more of a PSCCH, a PSSCH, a PSFCH, some other type of channel, or any combination thereof. In some examples, the communication and processing circuitry 1441 may include functionality for a means for sending (e.g., a means for transmitting). In some examples, the communication and processing circuitry 1441 may include functionality for a means for encoding. In some examples, the communication and processing circuitry 1441 and/or the transceiver 1410 may include functionality for a means for transmitting a message.

The processor 1404 may include random access configuration circuitry 1442 configured to perform random access configuration-related operations as discussed herein (e.g., one or more of the operations described above in conjunction with FIGS. 9-13). The random access configuration circuitry 1442 may be configured to execute random access configuration software 1452 included on the computer-readable medium 1406 to implement one or more functions described herein.

The random access configuration circuitry 1442 may include functionality for a means for receiving random access configuration information (e.g., as described above in conjunction with FIGS. 9-13). For example, the random access configuration circuitry 1442 may receive an RRC message including the configuration information from a network entity via a PDSCH.

The processor 1404 may include random access processing circuitry 1443 configured to perform random access processing-related operations as discussed herein (e.g., one or more of the operations described above in conjunction with FIGS. 9-13). The random access processing circuitry 1443 may be configured to execute random access processing software 1453 included on the computer-readable medium 1406 to implement one or more functions described herein.

The random access processing circuitry 1443 may include functionality for a means for transmitting a random access message (e.g., as described above in conjunction with FIGS. 9-13). For example, the random access processing circuitry 1443 may transmit a random access preamble on a selected random access resource.

The random access processing circuitry 1443 may include functionality for a means for receiving a random access message (e.g., as described above in conjunction with FIGS. 9-13). For example, the random access processing circuitry 1443 may receive a RAR message including TA information from a network entity.

FIG. 15 is a flow chart illustrating an example method 1500 for a user equipment in accordance with some aspects of the present disclosure. As described below, some or all illustrated features may be omitted in a particular implementation within the scope of the present disclosure, and some illustrated features may not be required for implementation of all examples. In some examples, the method 1500 (e.g., a method for wireless communication) may be carried out by the UE 1400 illustrated in FIG. 14. In some examples, the method 1500 may be carried out by any suitable apparatus or means for carrying out the functions or algorithm described below.

At block 1502, a user equipment may transmit a first random access message for a random access procedure to a network entity, the first random access message being transmitted via a first random access resource of a set of random access resources associated with a first control resource set pool index value of a plurality of control resource set pool index values. In some examples, the random access processing circuitry 1443 together with the communication and processing circuitry 1441 and the transceiver 1410, shown and described in FIG. 14, may provide a means to transmit a first random access message for a random access procedure to a network entity, the first random access message being transmitted via a first random access resource of a set of random access resources associated with a first control resource set pool index value of a plurality of control resource set pool index values.

At block 1504, the user equipment may receive a second random access message from the network entity, the second random access message including timing advance information. In some examples, the random access processing circuitry 1443 together with the communication and processing circuitry 1441 and the transceiver 1410, shown and described in FIG. 14, may provide a means to receive a second random access message from the network entity, the second random access message including timing advance information.

At block 1506, the user equipment may transmit a message to the network entity based on the timing advance information. In some examples, the random access processing circuitry 1443 together with the communication and processing circuitry 1441 and the transceiver 1410, shown and described in FIG. 14, may provide a means to transmit a message to the network entity based on the timing advance information.

In some examples, the user equipment may select the first random access resource from the set of random access resources associated with the first control resource set pool index value. In some examples, selecting the first random access resource may include selecting a first synchronization signal block from a set of synchronization signal blocks associated with the first control resource set pool index value.

In some examples, the user equipment may identify the set of synchronization signal blocks associated with the first control resource set pool index value based on a defined rule or a radio resource control configuration.

In some examples, to select the first synchronization signal block, the user equipment may identify, from the set of synchronization signal blocks associated with the first control resource set pool index value, at least one synchronization signal block associated with a received power level that is greater than or equal to a first threshold, and selecting one synchronization signal block of the at least one synchronization signal block.

In some examples, the first threshold is associated with the plurality of control resource set pool index values. In some examples, the first threshold is associated with the first control resource set pool index value, and a second threshold is associated with a second control resource set pool index value of the plurality of control resource set pool index values. In some examples, the first threshold is different from the second threshold. In some examples, the first threshold is the same as the second threshold.

In some examples, to select the first synchronization signal block, the user equipment may determine that no synchronization signal blocks of the set of synchronization signal blocks associated with the first control resource set pool index value are associated with a received power level that is greater than or equal to a first threshold, and selecting one synchronization signal block of the set of synchronization signal blocks associated with the first control resource set pool index value.

In some examples, the user equipment may identify a random access channel occasion associated with the first synchronization signal block, wherein the transmitting the first random access message may include transmitting the first random access message via the random access channel occasion.

In some examples, the user equipment may randomly select a first random access preamble from a set of random access preambles associated with the first synchronization signal block, wherein the first random access message may include the first random access preamble.

In some examples, the user equipment may receive a physical downlink control channel message that triggers the random access procedure, determine that the first control resource set pool index value is associated with the random access procedure based on the physical downlink control channel message, and select the first random access resource based on the determining that the first control resource set pool index value is associated with the random access procedure. In some examples, determining that the first control resource set pool index value is associated with the random access procedure may include identifying a control resource set pool index value associated with a control resource set in which the physical downlink control channel message is received. In some examples, determining that the first control resource set pool index value is associated with the random access procedure may include identifying a transmission configuration indicator associated with a control resource set in which the physical downlink control channel message is received, and identifying a control resource set pool index value associated with the transmission configuration indicator. In some examples, determining that the first control resource set pool index value is associated with the random access procedure may include identifying a control resource set pool index value included in a field of the physical downlink control channel message. In some examples, the field may include an uplink/supplemental uplink indicator field or a reserved bit field.

In some examples, the user equipment may determine that a time alignment timer expired, determine that the first control resource set pool index value is associated with the time alignment timer, and select the first random access resource based on the determining that the first control resource set pool index value is associated with the time alignment timer. In some examples, the user equipment may adjust uplink timing alignment based on the timing advance information (e.g., the random access procedure may enable adjusting uplink timing alignment based on a received TA value).

In some examples, the first random access message may include a random access channel preamble. In some examples, the second random access message may include a random access response message. In some examples, the set of random access resources may include a set of resources associated with a set of synchronization signal blocks.

FIG. 16 is a flow chart illustrating an example method 1600 for a user equipment in accordance with some aspects of the present disclosure. As described below, some or all illustrated features may be omitted in a particular implementation within the scope of the present disclosure, and some illustrated features may not be required for implementation of all examples. In some examples, the method 1600 may be carried out by the UE 1400 illustrated in FIG. 14. In some examples, the method 1600 may be carried out by any suitable apparatus or means for carrying out the functions or algorithm described below.

At block 1602, a user equipment may transmit a first random access message for a random access procedure to a network entity, the first random access message being transmitted via a first random access resource of a set of random access resources associated with a first physical cell identifier of a plurality of physical cell identifiers. In some examples, the random access processing circuitry 1443 together with the communication and processing circuitry 1441 and the transceiver 1410, shown and described in FIG. 14, may provide a means to transmit a first random access message for a random access procedure to a network entity, the first random access message being transmitted via a first random access resource of a set of random access resources associated with a first physical cell identifier of a plurality of physical cell identifiers.

At block 1604, the user equipment may receive a second random access message from the network entity, the second random access message including timing advance information. In some examples, the random access processing circuitry 1443 together with the communication and processing circuitry 1441 and the transceiver 1410, shown and described in FIG. 14, may provide a means to receive a second random access message from the network entity, the second random access message including timing advance information.

At block 1606, the user equipment may transmit a message to the network entity based on the timing advance information. In some examples, the random access processing circuitry 1443 together with the communication and processing circuitry 1441 and the transceiver 1410, shown and described in FIG. 14, may provide a means to transmit a message to the network entity based on the timing advance information.

In some examples, the user equipment may select the first random access resource from the set of random access resources associated with the first physical cell identifier.

In some examples, to select the first random access resource, the user equipment may select a first synchronization signal block from a set of synchronization signal blocks associated with the first physical cell identifier.

In some examples, the user equipment may receive a radio resource control configuration, and identify the set of synchronization signal blocks associated with the first physical cell identifier based on the radio resource control configuration.

In some examples, to select the first synchronization signal block the user equipment may identify, from the set of synchronization signal blocks associated with the first physical cell identifier, at least one synchronization signal block associated with a received power level that is greater than or equal to a first threshold, and select one synchronization signal block of the at least one synchronization signal block.

In some examples, the first threshold is associated with a physical cell identifier of a serving cell for the user equipment. In some examples, the first threshold is associated with the plurality of physical cell identifiers. In some examples, the first threshold is associated with the first physical cell identifier, and a second threshold is associated with a second physical cell identifier of the plurality of physical cell identifiers. In some examples, the first threshold is different from the second threshold. In some examples, the first threshold is the same as the second threshold.

In some examples, to select the first synchronization signal block the user equipment may determine that no synchronization signal blocks of the set of synchronization signal blocks associated with the first physical cell identifier are associated with a received power level that is greater than or equal to a first threshold, and select one synchronization signal block of the set of synchronization signal blocks associated with the first physical cell identifier.

In some examples, the user equipment may identify a random access channel occasion associated with the first synchronization signal block, wherein the transmitting the first random access message may include transmitting the first random access message via the random access channel occasion.

In some examples, the user equipment may randomly select a first random access preamble from a set of random access preambles associated with the first synchronization signal block, wherein the first random access message may include the first random access preamble.

In some examples, the user equipment may receive a physical downlink control channel message that triggers the random access procedure, determine that the first physical cell identifier is associated with the random access procedure based on an indication carried by a field of the physical downlink control channel message, and select the first random access resource based on the determining that the first physical cell identifier is associated with the random access procedure. In some examples, the field may include a reserved bit field. In some examples, the field may include a synchronization signal/physical broadcast channel index field or a physical random access channel mask index field.

Referring again to FIG. 14, in one configuration, the UE 1400 includes means for transmitting a first random access message for a random access procedure to a network entity, the first random access message being transmitted via a first random access resource of a set of random access resources associated with a first control resource set pool index value of a plurality of control resource set pool index values, means for receiving a second random access message from the network entity, the second random access message including timing advance information, and means for transmitting a message to the network entity based on the timing advance information. In one configuration, the UE 1400 includes means for transmitting a first random access message for a random access procedure to a network entity, the first random access message being transmitted via a first random access resource of a set of random access resources associated with a first physical cell identifier of a plurality of physical cell identifiers, means for receiving a second random access message from the network entity, the second random access message including timing advance information, and means for transmitting a message to the network entity based on the timing advance information. In one aspect, the aforementioned means may be the processor 1404 shown in FIG. 14 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable medium 1406, or any other suitable apparatus or means described in any one or more of FIGS. 1, 2, 3, 7, 8, 9, 13, and 14, and utilizing, for example, the methods and/or algorithms described herein in relation to FIGS. 15-16.

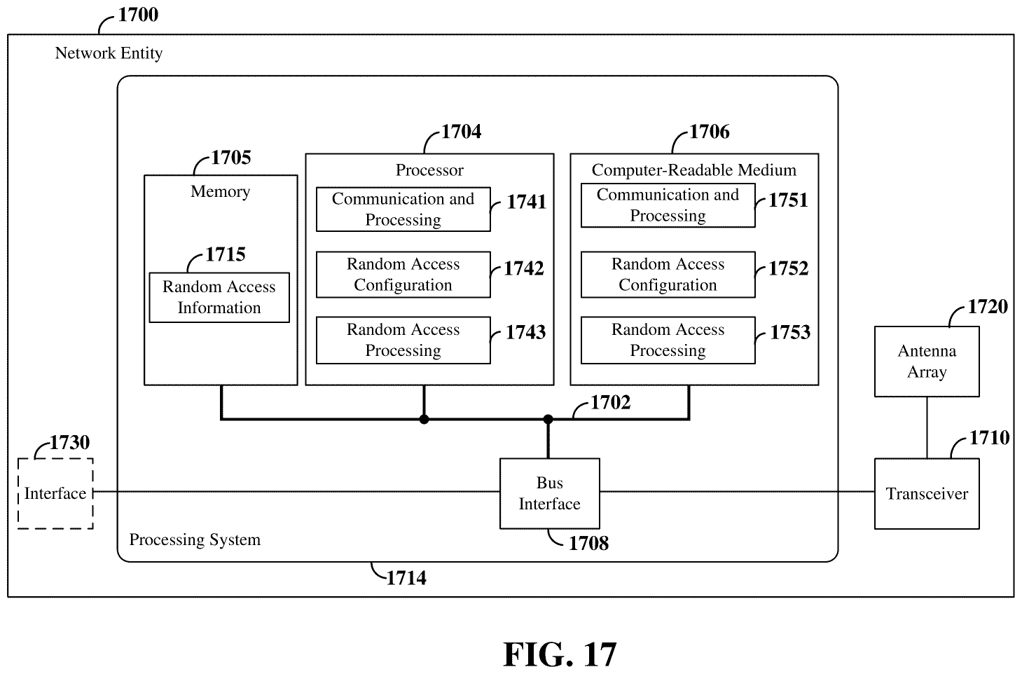

FIG. 17 is a conceptual diagram illustrating an example of a hardware implementation for a network entity 1700 employing a processing system 1714. In some implementations, the network entity 1700 may correspond to any of the network entities, base stations, CUs, DUs, RUs, or scheduling entities shown in any of FIGS. 1, 2, 3, 6, 8, 9, 11, 12, and 13.

In accordance with various aspects of the disclosure, an element, or any portion of an element, or any combination of elements may be implemented with the processing system 1714. The processing system may include one or more processors 1704. The processing system 1714 may be substantially the same as the processing system 1414 illustrated in FIG. 14, including a bus interface 1708, a bus 1702, memory 1705, a processor 1704, a computer-readable medium 1706, a transceiver 1710, and an antenna array 1720. The memory 1705 may store random access information 1715 (e.g., random access resource information) used by the processor 1704 in cooperation with the transceiver 1710 for communication operations as described herein. Furthermore, the network entity 1700 may include an interface 1730 (e.g., a network interface) that provides a means for communicating with at least one other apparatus within a core network and with at least one radio access network.

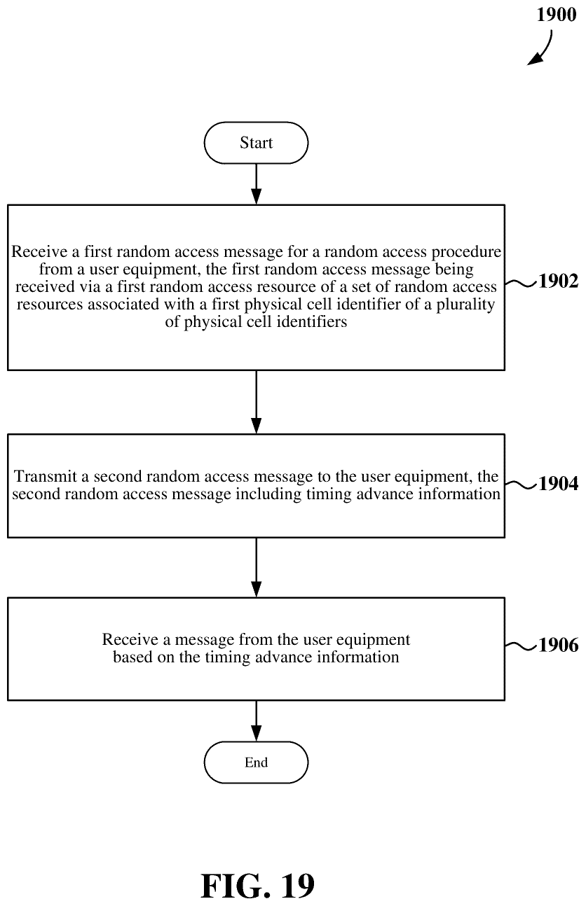

The network entity 1700 may be configured to perform any one or more of the operations described herein (e.g., as described above in conjunction with FIGS. 1-13 and as described below in conjunction with FIG. 19). In some aspects of the disclosure, the processor 1704, as utilized in the network entity 1700, may include circuitry configured for various functions.

The processor 1704 may be configured to generate, schedule, and modify a resource assignment or grant of time-frequency resources (e.g., a set of one or more resource elements). For example, the processor 1704 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1704 may be configured to schedule resources for the transmission of downlink signals. The processor 1704 may further be configured to schedule resources for the transmission of uplink signals.

In some aspects of the disclosure, the processor 1704 may include communication and processing circuitry 1741. The communication and processing circuitry 1741 may be configured to communicate with a user equipment. The communication and processing circuitry 1741 may include one or more hardware components that provide the physical structure that performs various processes related to communication (e.g., signal reception and/or signal transmission) as described herein. The communication and processing circuitry 1741 may further include one or more hardware components that provide the physical structure that performs various processes related to signal processing (e.g., processing a received signal and/or processing a signal for transmission) as described herein. The communication and processing circuitry 1741 may further be configured to execute communication and processing software 1751 included on the computer-readable medium 1706 to implement one or more functions described herein.

The communication and processing circuitry 1741 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 1741 may further be configured to receive a scheduling request from a UE for an uplink grant or a sidelink grant.

In some implementations wherein the communication involves receiving information, the communication and processing circuitry 1741 may obtain information from a component of the network entity 1700 (e.g., from the transceiver 1710 that receives the information via radio frequency signaling or some other type of signaling suitable for the applicable communication medium), process (e.g., decode) the information, and output the processed information. For example, the communication and processing circuitry 1741 may output the information to another component of the processor 1704, to the memory 1705, or to the bus interface 1708. In some examples, the communication and processing circuitry 1741 may receive one or more of signals, messages, other information, or any combination thereof. In some examples, the communication and processing circuitry 1741 may receive information via one or more channels. In some examples, the communication and processing circuitry 1741 may include functionality for a means for receiving. In some examples, the communication and processing circuitry 1741 may include functionality for a means for decoding. In some examples, the communication and processing circuitry 1741 and/or the transceiver 1710 may include functionality for a means for receiving a message.

In some implementations wherein the communication involves sending (e.g., transmitting) information, the communication and processing circuitry 1741 may obtain information (e.g., from another component of the processor 1704, the memory 1705, or the bus interface 1708), process (e.g., encode) the information, and output the processed information. For example, the communication and processing circuitry 1741 may output the information to the transceiver 1710 (e.g., that transmits the information via radio frequency signaling or some other type of signaling suitable for the applicable communication medium). In some examples, the communication and processing circuitry 1741 may send one or more of signals, messages, other information, or any combination thereof. In some examples, the communication and processing circuitry 1741 may send information via one or more channels. In some examples, the communication and processing circuitry 1741 may include functionality for a means for sending (e.g., a means for transmitting). In some examples, the communication and processing circuitry 1741 may include functionality for a means for encoding. In some examples, the communication and processing circuitry 1741 and/or the transceiver 1710 may include functionality for a means for transmitting a message.

The processor 1704 may include random access configuration circuitry 1742 configured to perform random access configuration-related operations as discussed herein (e.g., one or more of the operations described above in conjunction with FIGS. 9-13). The random access configuration circuitry 1742 may be configured to execute random access configuration software 1752 included on the computer-readable medium 1706 to implement one or more functions described herein.

The random access configuration circuitry 1742 may include functionality for a means for transmitting random access configuration information (e.g., as described above in conjunction with FIGS. 9-13). For example, the random access configuration circuitry 1742 may transmit an RRC message including the configuration information to a UE via a PDSCH.

The processor 1704 may include random access processing circuitry 1743 configured to perform random access processing-related operations as discussed herein (e.g., one or more of the operations described above in conjunction with FIGS. 9-13). The random access processing circuitry 1743 may be configured to execute random access processing software 1753 included on the computer-readable medium 1706 to implement one or more functions described herein.

The random access processing circuitry 1743 may include functionality for a means for transmitting a random access message (e.g., as described above in conjunction with FIGS. 9-13). For example, the random access processing circuitry 1743 may transmit a RAR message including TA information to a UE.

The random access processing circuitry 1743 may include functionality for a means for receiving a random access message (e.g., as described above in conjunction with FIGS. 9-13). For example, the random access processing circuitry 1743 may receive a random access preamble on a random access resource associated with a TRP.

In some examples, the network entity 1700 shown and described above in connection with FIG. 17 may be a disaggregated base station. For example, the network entity 1700 shown in FIG. 17 may include the CU and optionally one or more DUs/RUs of the disaggregated base station. Other DUs/RUs associated with the network entity 1700 may be distributed throughout the network. In some examples, the DUs/RUs may correspond to TRPs associated with the network entity. In some examples, the CU and/or DU/RU of the disaggregated base station (e.g., within the network entity 1700) may generate a random access message (e.g., including a TA value) and provide the random access message to a user equipment, as well as receive and process random access messages from the user equipment.

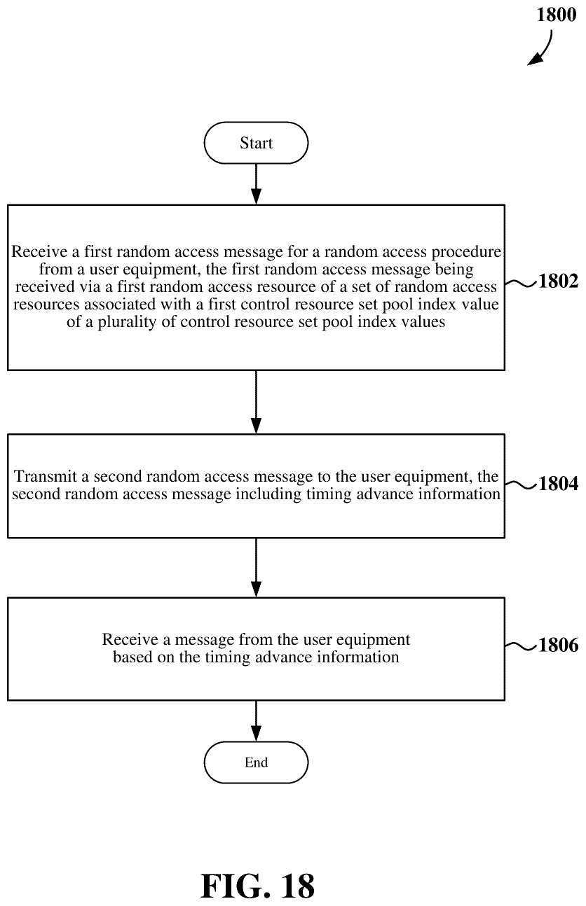

FIG. 18 is a flow chart illustrating an example method 1800 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1800 may be carried out by the network entity 1700 illustrated in FIG. 17. In some examples, the method 1800 may be carried out by any suitable apparatus or means for carrying out the functions or algorithm described below.

At block 1802, a network entity may receive a first random access message for a random access procedure from a user equipment, the first random access message being received via a first random access resource of a set of random access resources associated with a first control resource set pool index value of a plurality of control resource set pool index values. In some examples, the random access processing circuitry 1743 together with the communication and processing circuitry 1741 and the transceiver 1710, shown and described in FIG. 17, may provide a means to receive a first random access message for a random access procedure from a user equipment, the first random access message being received via a first random access resource of a set of random access resources associated with a first control resource set pool index value of a plurality of control resource set pool index values.

At block 1804, the network entity may transmit a second random access message to the user equipment, the second random access message including timing advance information. In some examples, the random access processing circuitry 1743 together with the communication and processing circuitry 1741 and the transceiver 1710, shown and described in FIG. 17, may provide a means to transmit a second random access message to the user equipment, the second random access message including timing advance information.

At block 1806, the network entity may receive a message from the user equipment based on the timing advance information. In some examples, the random access processing circuitry 1743 together with the communication and processing circuitry 1741 and the transceiver 1710, shown and described in FIG. 17, may provide a means to receive a message from the user equipment based on the timing advance information.

In some examples, the set of random access resources may include a set of resources associated with a set of synchronization signal blocks.

In some examples, the network entity may transmit a radio resource control configuration to the user equipment, the radio resource control configuration indicating that the set of synchronization signal blocks is associated with the first control resource set pool index value.

In some examples, the network entity may transmit a physical downlink control channel message that triggers the random access procedure.

In some examples, the first control resource set pool index value is associated with a control resource set in which the physical downlink control channel message is transmitted. In some examples, the first control resource set pool index value is associated with a transmission configuration indicator that is associated with a control resource set in which the physical downlink control channel message is transmitted.

In some examples, a field of the physical downlink control channel message indicates that the first control resource set pool index value is associated with the random access procedure. In some examples, the field may include an uplink/supplemental uplink indicator field or a reserved bit field.

FIG. 19 is a flow chart illustrating an example method 1900 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1900 may be carried out by the network entity 1700 illustrated in FIG. 17. In some examples, the method 1900 may be carried out by any suitable apparatus or means for carrying out the functions or algorithm described below.

At block 1902, a network entity may receive a first random access message for a random access procedure from a user equipment, the first random access message being received via a first random access resource of a set of random access resources associated with a first physical cell identifier of a plurality of physical cell identifiers. In some examples, the random access processing circuitry 1743 together with the communication and processing circuitry 1741 and the transceiver 1710, shown and described in FIG. 17, may provide a means to receive a first random access message for a random access procedure from a user equipment, the first random access message being received via a first random access resource of a set of random access resources associated with a first physical cell identifier of a plurality of physical cell identifiers.

At block 1904, the network entity may transmit a second random access message to the user equipment, the second random access message including timing advance information. In some examples, the random access processing circuitry 1743 together with the communication and processing circuitry 1741 and the transceiver 1710, shown and described in FIG. 17, may provide a means to transmit a second random access message to the user equipment, the second random access message including timing advance information.

At block 1906, the network entity may receive a message from the user equipment based on the timing advance information. In some examples, the random access processing circuitry 1743 together with the communication and processing circuitry 1741 and the transceiver 1710, shown and described in FIG. 17, may provide a means to receive a message from the user equipment based on the timing advance information.

In some examples, the set of random access resources may include a set of resources associated with a set of synchronization signal blocks.

In some examples, the network entity may transmit a radio resource control configuration to the user equipment, the radio resource control configuration indicating that the set of synchronization signal blocks is associated with the first physical cell identifier.

In some examples, the network entity may transmit a physical downlink control channel message that triggers the random access procedure.

In some examples, a field of the physical downlink control channel message indicates that the first physical cell identifier is associated with the random access procedure. In some examples, the field may include a reserved bit field. In some examples, the field may include a synchronization signal/physical broadcast channel index field or a physical random access channel mask index field.

Referring again to FIG. 17, in one configuration, the network entity 1700 includes means for receiving a first random access message for a random access procedure from a user equipment, the first random access message being received via a first random access resource of a set of random access resources associated with a first control resource set pool index value of a plurality of control resource set pool index values, means for transmitting a second random access message to the user equipment, the second random access message including timing advance information, and means for receiving a message from the user equipment based on the timing advance information. In one configuration, the network entity 1700 includes means for receiving a first random access message for a random access procedure from a user equipment, the first random access message being received via a first random access resource of a set of random access resources associated with a first physical cell identifier of a plurality of physical cell identifiers, means for transmitting a second random access message to the user equipment, the second random access message including timing advance information, and means for receiving a message from the user equipment based on the timing advance information. In one aspect, the aforementioned means may be the processor 1704 shown in FIG. 17 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable medium 1706, or any other suitable apparatus or means described in any one or more of FIGS. 1, 2, 3, 6, 8, 9, 11, 12, 13, and 17, and utilizing, for example, the methods and/or algorithms described herein in relation to FIGS. 18-19.

The methods shown in FIGS. 15-16 and 18-19 may include additional aspects, such as any single aspect or any combination of aspects described below and/or in connection with one or more other processes described elsewhere herein. The following provides an overview of several aspects of the present disclosure.
Aspect 1: A method for wireless communication at a user equipment, the method comprising: transmitting a first random access message for a random access procedure to a network entity, the first random access message being transmitted via a first random access resource of a set of random access resources associated with a first control resource set pool index value of a plurality of control resource set pool index values; receiving a second random access message from the network entity, the second random access message including timing advance information; and transmitting a message to the network entity based on the timing advance information.
Aspect 2: The method of aspect 1, further comprising: selecting the first random access resource from the set of random access resources associated with the first control resource set pool index value.
Aspect 3: The method of aspect 2, wherein the selecting the first random access resource comprises: selecting a first synchronization signal block from a set of synchronization signal blocks associated with the first control resource set pool index value
Aspect 4: The method of aspect 3, further comprising: identifying the set of synchronization signal blocks associated with the first control resource set pool index value based on a defined rule or a radio resource control configuration.
Aspect 5: The method of aspect 3, wherein the selecting the first synchronization signal block comprises: identifying, from the set of synchronization signal blocks associated with the first control resource set pool index value, at least one synchronization signal block associated with a received power level that is greater than or equal to a first threshold; and selecting one synchronization signal block of the at least one synchronization signal block.
Aspect 6: The method of aspect 5, wherein the first threshold is associated with the plurality of control resource set pool index values.
Aspect 7: The method of aspect 5, wherein: the first threshold is associated with the first control resource set pool index value; and a second threshold is associated with a second control resource set pool index value of the plurality of control resource set pool index values; and the first threshold is different from the second threshold.
Aspect 8: The method of aspect 5, wherein: the first threshold is associated with the first control resource set pool index value; and a second threshold is associated with a second control resource set pool index value of the plurality of control resource set pool index values; and the first threshold is the same as the second threshold.
Aspect 9: The method of any of aspects 3 through 8, wherein the selecting the first synchronization signal block comprises: determining that no synchronization signal blocks of the set of synchronization signal blocks associated with the first control resource set pool index value are associated with a received power level that is greater than or equal to a first threshold; and selecting one synchronization signal block of the set of synchronization signal blocks associated with the first control resource set pool index value.
Aspect 10: The method of any of aspects 3 through 9, further comprising: identifying a random access channel occasion associated with the first synchronization signal block, wherein the transmitting the first random access message comprises transmitting the first random access message via the random access channel occasion.
Aspect 11: The method of any of aspects 3 through 10, further comprising: randomly selecting a first random access preamble from a set of random access preambles associated with the first synchronization signal block, wherein the first random access message comprises the first random access preamble.
Aspect 12: The method of any of aspects 1 through 11, further comprising: receiving a physical downlink control channel message that triggers the random access procedure; determining that the first control resource set pool index value is associated with the random access procedure based on the physical downlink control channel message; and selecting the first random access resource based on the determining that the first control resource set pool index value is associated with the random access procedure.
Aspect 13: The method of aspect 12, wherein the determining that the first control resource set pool index value is associated with the random access procedure comprises: identifying a control resource set pool index value associated with a control resource set in which the physical downlink control channel message is received.
Aspect 14: The method of aspect 12, wherein the determining that the first control resource set pool index value is associated with the random access procedure comprises: identifying a transmission configuration indicator associated with a control resource set in which the physical downlink control channel message is received; and identifying a control resource set pool index value associated with the transmission configuration indicator.
Aspect 15: The method of aspect 12, wherein the determining that the first control resource set pool index value is associated with the random access procedure comprises: identifying a control resource set pool index value included in a field of the physical downlink control channel message.
Aspect 16: The method of aspect 15, wherein the field comprises an uplink/supplemental uplink indicator field or a reserved bit field.
Aspect 17: The method of any of aspects 1 through 16, further comprising: determining that a time alignment timer expired; determining that the first control resource set pool index value is associated with the time alignment timer; and selecting the first random access resource based on the determining that the first control resource set pool index value is associated with the time alignment timer.
Aspect 18: The method of any of aspects 1 through 17, further comprising: adjusting uplink timing alignment based on the timing advance information.
Aspect 19: The method of any of aspects 1 through 18, wherein: the first random access message comprises a random access channel preamble; and the second random access message comprises a random access response message.
Aspect 20: The method of any of aspects 1 through 19, wherein the set of random access resources comprises a set of resources associated with a set of synchronization signal blocks.
Aspect 21: A method for wireless communication at a user equipment, the method comprising: transmitting a first random access message for a random access procedure to a network entity, the first random access message being transmitted via a first random access resource of a set of random access resources associated with a first physical cell identifier of a plurality of physical cell identifiers; receiving a second random access message from the network entity, the second random access message including timing advance information; and transmitting a message to the network entity based on the timing advance information.
Aspect 22: The method of aspect 21, further comprising: selecting the first random access resource from the set of random access resources associated with the first physical cell identifier.
Aspect 23: The method of aspect 22, wherein the selecting the first random access resource comprises: selecting a first synchronization signal block from a set of synchronization signal blocks associated with the first physical cell identifier.
Aspect 24: The method of aspect 23, further comprising: receiving a radio resource control configuration; and identifying the set of synchronization signal blocks associated with the first physical cell identifier based on the radio resource control configuration.
Aspect 25: The method of aspect 23, wherein the selecting the first synchronization signal block comprises: identifying, from the set of synchronization signal blocks associated with the first physical cell identifier, at least one synchronization signal block associated with a received power level that is greater than or equal to a first threshold; and selecting one synchronization signal block of the at least one synchronization signal block.
Aspect 26: The method of aspect 25, wherein the first threshold is associated with a physical cell identifier of a serving cell for the user equipment.
Aspect 27: The method of aspect 25, wherein the first threshold is associated with the plurality of physical cell identifiers.
Aspect 28: The method of aspect 25, wherein: the first threshold is associated with the first physical cell identifier; a second threshold is associated with a second physical cell identifier of the plurality of physical cell identifiers; and the first threshold is different from the second threshold.
Aspect 29: The method of aspect 25, wherein: the first threshold is associated with the first physical cell identifier; a second threshold is associated with a second physical cell identifier of the plurality of physical cell identifiers; and the first threshold is the same as the second threshold.
Aspect 30: The method of any of aspects 23 through 29, wherein the selecting the first synchronization signal block comprises: determining that no synchronization signal blocks of the set of synchronization signal blocks associated with the first physical cell identifier are associated with a received power level that is greater than or equal to a first threshold; and selecting one synchronization signal block of the set of synchronization signal blocks associated with the first physical cell identifier.
Aspect 31: The method of any of aspects 23 through 30, further comprising: identifying a random access channel occasion associated with the first synchronization signal block, wherein the transmitting the first random access message comprises transmitting the first random access message via the random access channel occasion.
Aspect 32: The method of any of aspects 23 through 31, further comprising: randomly selecting a first random access preamble from a set of random access preambles associated with the first synchronization signal block, wherein the first random access message comprises the first random access preamble.
Aspect 33: The method of any of aspects 21 through 32, further comprising: receiving a physical downlink control channel message that triggers the random access procedure; determining that the first physical cell identifier is associated with the random access procedure based on an indication carried by a field of the physical downlink control channel message; and selecting the first random access resource based on the determining that the first physical cell identifier is associated with the random access procedure.
Aspect 34: The method of aspect 33, wherein the field comprises a reserved bit field.
Aspect 35: The method of aspect 33, wherein the field comprises a synchronization signal/physical broadcast channel index field or a physical random access channel mask index field.
Aspect 36: A method for wireless communication at a network entity, the method comprising: receiving a first random access message for a random access procedure from a user equipment, the first random access message being received via a first random access resource of a set of random access resources associated with a first control resource set pool index value of a plurality of control resource set pool index values; transmitting a second random access message to the user equipment, the second random access message including timing advance information; and receiving a message from the user equipment based on the timing advance information.
Aspect 37: The method of aspect 36, wherein the set of random access resources comprises a set of resources associated with a set of synchronization signal blocks.
Aspect 38: The method of aspect 37, further comprising: transmitting a radio resource control configuration to the user equipment, the radio resource control configuration indicating that the set of synchronization signal blocks is associated with the first control resource set pool index value.
Aspect 39: The method of any of aspects 36 through 38, further comprising: transmitting a physical downlink control channel message that triggers the random access procedure.
Aspect 40: The method of aspect 39, wherein the first control resource set pool index value is associated with a control resource set in which the physical downlink control channel message is transmitted.
Aspect 41: The method of aspect 39, wherein the first control resource set pool index value is associated with a transmission configuration indicator that is associated with a control resource set in which the physical downlink control channel message is transmitted.
Aspect 42: The method of aspect 39, wherein a field of the physical downlink control channel message indicates that the first control resource set pool index value is associated with the random access procedure.
Aspect 43: The method of aspect 42, wherein the field comprises an uplink/supplemental uplink indicator field or a reserved bit field.
Aspect 44: A method for wireless communication at a network entity, the method comprising: receiving a first random access message for a random access procedure from a user equipment, the first random access message being received via a first random access resource of a set of random access resources associated with a first physical cell identifier of a plurality of physical cell identifiers; transmitting a second random access message to the user equipment, the second random access message including timing advance information; and receiving a message from the user equipment based on the timing advance information.
Aspect 45: The method of aspect 44, wherein the set of random access resources comprises a set of resources associated with a set of synchronization signal blocks.
Aspect 46: The method of aspect 45, further comprising: transmitting a radio resource control configuration to the user equipment, the radio resource control configuration indicating that the set of synchronization signal blocks is associated with the first physical cell identifier.
Aspect 47: The method of any of aspects 44 through 46, further comprising: transmitting a physical downlink control channel message that triggers the random access procedure.
Aspect 48: The method of aspect 47, wherein a field of the physical downlink control channel message indicates that the first physical cell identifier is associated with the random access procedure.
Aspect 49: The method of aspect 48, wherein the field comprises a reserved bit field.
Aspect 50: The method of aspect 48, wherein the field comprises a synchronization signal/physical broadcast channel index field or a physical random access channel mask index field.
Aspect 51: A user equipment comprising: a transceiver configured to communicate with a radio access network, a memory, and a processor coupled to the transceiver and the memory, wherein the processor and the memory are configured to perform any one or more of aspects 1 through 20.
Aspect 52: An apparatus configured for wireless communication comprising at least one means for performing any one or more of aspects 1 through 20.
Aspect 53: A non-transitory computer-readable medium storing computer-executable code, comprising code for causing an apparatus to perform any one or more of aspects 1 through 20.
Aspect 54: A user equipment comprising: a transceiver configured to communicate with a radio access network, a memory, and a processor coupled to the transceiver and the memory, wherein the processor and the memory are configured to perform any one or more of aspects 21 through 35.
Aspect 55: An apparatus configured for wireless communication comprising at least one means for performing any one or more of aspects 21 through 35.
Aspect 56: A non-transitory computer-readable medium storing computer-executable code, comprising code for causing an apparatus to perform any one or more of aspects 21 through 35.
Aspect 57: A network entity comprising: a transceiver, a memory, and a processor coupled to the transceiver and the memory, wherein the processor and the memory are configured to perform any one or more of aspects 36 through 43.
Aspect 58: An apparatus configured for wireless communication comprising at least one means for performing any one or more of aspects 36 through 43.
Aspect 59: A non-transitory computer-readable medium storing computer-executable code, comprising code for causing an apparatus to perform any one or more of aspects 36 through 43.
Aspect 60: A network entity comprising: a transceiver, a memory, and a processor coupled to the transceiver and the memory, wherein the processor and the memory are configured to perform any one or more of aspects 44 through 50.
Aspect 61: An apparatus configured for wireless communication comprising at least one means for performing any one or more of aspects 44 through 50.
Aspect 62: A non-transitory computer-readable medium storing computer-executable code, comprising code for causing an apparatus to perform any one or more of aspects 445 through 50.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 6, 8, 9, 11, 12, 13, 14, and 17 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” (e.g., comprising at least one of or comprises at least one of) a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication at a user equipment, the method comprising:
transmitting a first random access message for a random access procedure to a network entity, the first random access message being transmitted via a first random access resource of a set of random access resources associated with a first control resource set pool index value of a plurality of control resource set pool index values;
receiving a second random access message from the network entity, the second random access message including timing advance information; and
transmitting a message to the network entity based on the timing advance information.

2-50. (canceled)

51. A user equipment, comprising:
one or more memories that store processor-executable code; and
one or more processors configured to execute the processor-executable code and cause the user equipment to:
transmit a first random access message for a random access procedure to a network entity, the first random access message being transmitted via a first random access resource of a set of random access resources associated with a first control resource set pool index value of a plurality of control resource set pool index values;
receive a second random access message from the network entity, the second random access message including timing advance information; and
transmit a message to the network entity based on the timing advance information.

52. The user equipment of claim 51, wherein the one or more processors are further configured to execute the processor-executable code and cause the user equipment to:
select the first random access resource from the set of random access resources associated with the first control resource set pool index value.

53. The user equipment of claim 52, wherein the one or more processors are further configured to execute the processor-executable code and cause the user equipment to:
select a first synchronization signal block from a set of synchronization signal blocks associated with the first control resource set pool index value.

54. (canceled)

55. The user equipment of claim 53, wherein the one or more processors are further configured to execute the processor-executable code and cause the user equipment to:
identify, from the set of synchronization signal blocks associated with the first control resource set pool index value, at least one synchronization signal block associated with a received power level that is greater than or equal to a first threshold; and
select one synchronization signal block of the at least one synchronization signal block.

56. (canceled)

57. The user equipment of claim 55, wherein:
the first threshold is associated with the first control resource set pool index value;
a second threshold is associated with a second control resource set pool index value of the plurality of control resource set pool index values; and
the first threshold is different from the second threshold.

58. (canceled)

59. The user equipment of claim 53, wherein the one or more processors are further configured to execute the processor-executable code and cause the user equipment to:
determine that no synchronization signal blocks of the set of synchronization signal blocks associated with the first control resource set pool index value are associated with a received power level that is greater than or equal to a first threshold; and
select one synchronization signal block of the set of synchronization signal blocks associated with the first control resource set pool index value.

60. The user equipment of claim 53, wherein:
the one or more processors are further configured to execute the processor-executable code and cause the user equipment to identify a random access channel occasion associated with the first synchronization signal block; and
the transmission of the first random access message comprises a transmission of the first random access message via the random access channel occasion.

61. The user equipment of claim 53, wherein:
the one or more processors are further configured to execute the processor-executable code and cause the user equipment to randomly select a first random access preamble from a set of random access preambles associated with the first synchronization signal block; and
the first random access message comprises the first random access preamble.

62. The user equipment of claim 51, wherein the one or more processors are further configured to execute the processor-executable code and cause the user equipment to:
receive a physical downlink control channel message that triggers the random access procedure;
determine that the first control resource set pool index value is associated with the random access procedure based on the physical downlink control channel message; and
select the first random access resource based on the determination that the first control resource set pool index value is associated with the random access procedure.

63. The user equipment of claim 62, wherein the one or more processors are further configured to execute the processor-executable code and cause the user equipment to:
identify a control resource set pool index value associated with a control resource set in which the physical downlink control channel message is received.

64-70. (canceled)

71. A user equipment, comprising:
one or more memories that store processor-executable code; and
one or more processors configured to execute the processor-executable code and cause the user equipment to:
transmit a first random access message for a random access procedure to a network entity, the first random access message being transmitted via a first random access resource of a set of random access resources associated with a first physical cell identifier of a plurality of physical cell identifiers;
receive a second random access message from the network entity, the second random access message including timing advance information; and
transmit a message to the network entity based on the timing advance information.

72. The user equipment of claim 71, wherein the one or more processors are further configured to execute the processor-executable code and cause the user equipment to:
select the first random access resource from the set of random access resources associated with the first physical cell identifier.

73. The user equipment of claim 72, wherein the one or more processors are further configured to execute the processor-executable code and cause the user equipment to:
select a first synchronization signal block from a set of synchronization signal blocks associated with the first physical cell identifier.

74. The user equipment of claim 73, wherein the one or more processors are further configured to execute the processor-executable code and cause the user equipment to:
receive a radio resource control configuration; and
identify the set of synchronization signal blocks associated with the first physical cell identifier based on the radio resource control configuration.

75. The user equipment of claim 73, wherein the one or more processors are further configured to execute the processor-executable code and cause the user equipment to:
identify, from the set of synchronization signal blocks associated with the first physical cell identifier, at least one synchronization signal block associated with a received power level that is greater than or equal to a first threshold; and
select one synchronization signal block of the at least one synchronization signal block.

76. (canceled)

77. (canceled)

78. The user equipment of claim 75, wherein:
the first threshold is associated with the first physical cell identifier;
a second threshold is associated with a second physical cell identifier of the plurality of physical cell identifiers; and
the first threshold is different from the second threshold.

79. (canceled)

80. The user equipment of claim 73, wherein the one or more processors are further configured to execute the processor-executable code and cause the user equipment to:
determine that no synchronization signal blocks of the set of synchronization signal blocks associated with the first physical cell identifier are associated with a received power level that is greater than or equal to a first threshold; and
select one synchronization signal block of the set of synchronization signal blocks associated with the first physical cell identifier.

81. (canceled)

82. (canceled)

83. The user equipment of claim 71, wherein the one or more processors are further configured to execute the processor-executable code and cause the user equipment to:
receive a physical downlink control channel message that triggers the random access procedure;
determine that the first physical cell identifier is associated with the random access procedure based on an indication carried by a field of the physical downlink control channel message; and
select the first random access resource based on the determination that the first physical cell identifier is associated with the random access procedure.

84. The user equipment of claim 83, wherein the field comprises a reserved bit field.

85-108. (canceled)
